(19) United States
(12) Patent Application Publication
(10) Pub. No.: US 2008/0255880 A1
(43) Pub. Date: Oct. 16, 2008

(54) Plan-of-Care Order-Execution-Management Software System

(76) Inventors: Stephen E. Beller, Croton On Hudson, NY (US); Sabatini J. Monatesti, Berwick, PA (US)

Correspondence Address: Stephen E. Beller, 130 Hastings Ave., Croton On Hudson, NY, 10520, US

(21) Appl. No.: 11/735,525

(22) Filed: Apr. 16, 2007

(51) Int. Cl. G06Q 50/00

(52) U.S. Cl. 705/3

(57) ABSTRACT

A method and apparatus that assists healthcare workers in managing each patient's “plan of care” (PoC). It consists of automated and semi-automated software modules integrated into a single system that perform processes for streamlining care planning, delivery and continuous quality improvement. These processes include establishing patients' PoCs, evaluating required POCs against available resource, notifying staff when resource shortages exist or are projected, adjusting PoCs to account for resource shortages, tracking the execution of PoC Orders, altering the Orders when they are not executed in a timely manner, adjusting PoCs to account for problems with Order execution, and presenting analytic reports of healthcare delivery performance.

### BACKGROUND

1. Field of Invention

This invention relates to the field of information systems and decision-support for use in healthcare environments. In particular, it combines into one system methods and processes for establishing plans-of-care for each patient, managing resource availability against actual and projected needs, managing plan-of-care delivery, tracking variances from plans-of-care and reasons for the variances, alerting personnel and adjusting plans-of-care when resource shortages or other problems arise, and analyzing and reporting healthcare delivery performance.

2. Description of Prior Art

I. Five Core Healthcare Processes

The invention is relevant to five core healthcare processes:
(1) generating and updating a plan-of-care (PoC) that defines a treatment regimen (i.e., clinical actions or measures such as procedures, assessments, medications, therapies, and other healthcare interventions);
(2) tracking and managing the resources required to execute the PoC successfully;
(3) guiding the PoC execution through alerts and warnings;
(4) tracking and reporting variances from the PoC (i.e., deviations from the recommended interventions); and
(5) tracking and reporting outcomes (i.e., the cost and results of care).

Healthcare providers (doctors, nurses, etc.) have access to health information technology (HIT) applications (i.e., software products) that assist them with each of these processes.

II. Definition of Key Terms and HIT Applications

A. Terms related to Treatment Plans

Several key terms concerning treatment plans are:
Plan-of-Care (PoC). A PoC is a treatment plan that establishes the goals and presents the details of the interventions (i.e., clinical actions or measures such as procedures, assessments, medications, therapies, and other interventions) for a particular episode of care for a particular patient, which is defined by practice guidelines or clinical pathways (described below).
Practice guideline (PG) and clinical pathway (CP). A PoC may be defined by a PG or CP. PGs are recommendations about the most appropriate interventions for people with specific diseases and conditions, which typically reflect a consensus that has been reached or approximated by experts. CPs, on the other hand, are broader frameworks for organizing the care of patient populations in that they define who should implement the interventions and when they should do it. In a CP, interventions are mapped on a timeline that spans multiple hours or days of care.
Order. Each intervention is called an Order. An Order is comprised of a single clinical action or measure, or a series of clinical actions and measures. For example, a “draw blood” Order typically involves a protocol consisting of the actions of obtaining the necessary supplies (a needle, vial, band aid, etc.), preparing the patient, drawing the blood, labeling and sending the blood to the laboratory for analysis, and receiving the lab report. Any number of Orders can be included in a single PoC. Each Order has an expected outcome that defines whether it was successfully executed. PGs and CPs define the Orders to be implemented in a patient's PoC.
Order information OI). An Order's OI consists of detailed information about how and when an Order is to be executed. A partial list of possible data comprising and Order's OI includes: timeframes for its execution; dependencies, i.e., prior Orders that must be executed before the current Order and subsequent Orders that depend on the execution of the current; queuing instructions for Order execution and resource management; priority status indicator; anticipated number of days of care that will be necessary; resources required for its execution; instructions about what to do if the Order is executed early or late; instructional materials for the healthcare provider; educational materials for the patient (and/or patient's family member); expected and/or desired outcomes; cost data; alternative Orders should there be problems executing the primary Orders; staff member qualifications necessary for executing the Order; follow-up care instructions; and other suitable information.
Queues. A queue is means for storing and accessing data, known as “transactions,” that are awaiting processing. Queues behave as a buffer between the components of a software system in that an arriving transaction waits for a request for the transaction from a downstream component before sending it on that component. There are different methods for determining the placement of a transaction in a queue, such as first-in-last-out (FILO), last-in-first-out (LIFO), and Priority Queues. The LIFO and FIFO queues order transactions according to their arrival time. The Priority Queue determines placement of a transaction in queue based on the value of the priority status indicator, and may re-sort the order of transactions within it based on the requirements imposed on resources by external events.
A queue has a memory means that stores transactions and a processing means that determines where and when transactions are sent.
In the preferred embodiment of the invention, a group of five queues is used, which are described later. These queues are used to store and give access to data about PoC Orders' resource requirements, resource availability, and execution. In alternate embodiments, multiple groups of queues may be used and a group may have more or less than five queues.

B. HIT Applications and Functions

HIT applications. The invention may utilize several types of existing automated and semi-automated HIT applications, including electronic health record (EHR) and computerized physician Order entry (CPOE) applications, as well as computerized practice guidelines (CPGs) and computerized clinical pathways (CCPs). Note that some or all of the processes provided by this constellation of software applications may be contained in a single software application (e.g., an EHR could provide both CPOE and CPG functionality), or different processes can be executed by separate software applications. Each of these applications is described below:
Electronic Health Record (EHR). EHRs, which include electronic medical record and personal health record systems, manage patients' health information, including their medical history, allergies, current medication use, existing health conditions and risk factors, demographics, etc. They may be limited to a single area of clinical information (such as laboratory data) or designed for a specific healthcare specialty, or they may be very broad in scope and multidisciplinary. At minimum, these systems include a user interface (UI) and database. Note that an EHR may enable a plurality of end-users to use a plurality of EHR user interfaces.
Health Information Management System (HIMS). Health Information Management Systems provide sophisticated tools and services to capture, classify, and operationalize healthcare data.

These data, when accurately compiled and effectively used, may drive an organization's ability to manage revenue and resources, comply with regulations, and ultimately improve the quality of patient care. However, in organizations using a manual data input process, there is little impact on care quality in real-time. Once healthcare data is entered in a HIMS, a claims or inventory system is invoked to submit a transaction for reimbursement, inventory replenishment, billing, or continued action by multidisciplinary teams.
Computerized Physician Order Entry (CPOE). CPOEs enable healthcare providers to generate a plan-of-care (PoC) for their patients by selecting one or more Orders individually, or by selecting “standing orders” consisting of predefined lists of Orders associated with a medical condition (diagnosis). CPOEs are designed to enhance legibility, reduce duplication, and improve the speed with which Orders are executed. In addition to electronic prescribing, they may include electronic referrals radiology and laboratory ordering and results display, the ability to track Order execution, and offer support for continuing medical education. Their decision support functions may include a menu of medications with default doses and a range of potential doses for each medication. They may check for drug-allergy contradictions and drug-drug interactions, do drug-laboratory value checks, and display a patient's relevant laboratory results on the screen at the time of ordering. They may warn the physician about possible adverse drug interactions and improper dosages. In addition to providing reminders about corollary Orders (e.g., prompting the physician to order glucose checks after ordering insulin), and they may display guidelines as the Order is being made. At minimum, CPOEs include a user interface (UI) and database. Some CPOEs may be incorporated into an EHR and share the same database. Note that a CPOE may enable a plurality of end-users to use a plurality of CPOE user interfaces.
Computerized Practice guideline (CPG) and Computerized Clinical pathway (CCP). When a PG is computerized, it is called a computerized practice guideline. When a clinical pathway is computerized, it is called a computerized clinical pathway. CPGs and CCPs help healthcare providers deliver care by describing explicit standards of care for specific health problems using different rules (algorithms) to determine which treatment interventions to recommend for a patient.

C. Care Execution Management (CEM) Application

No matter what combination of HIT applications is utilized, the invention integrates them into a single software system through use of a care execution management (CEM) application. The CEM provides executive functions for the entire integrated system, which streamlines certain PoC processes, provides decision support, gives timely feedback to healthcare workers when certain processes are failing, enables the failing processes to be remedied, and tracks and reports key information about care delivery and outcomes.

Note that the CEM may interoperate with a plurality of technologies, which may, for example, help determine if trauma centers have the resources necessary to handle victims in emergency situations. One way this may be done is by linking, via the Internet, CEMs used by first responder units and by staff in trauma centers, which access disparate databases and software applications and present essential information for managing an event using dashboard interface portals. Connectivity between the CEMs, databases and applications could occur in an asynchronous manner using node-to-node, publisher-subscriber technology that ensures interoperability is maintained between and among the first response unit and the trauma centers.

Note that there may be one or a plurality of CEM applications in a facility, e.g., a CEM application for each department.

D. Objects, Class, Inheritance, Attributes

From a macro level integration perspective, the preferred embodiment of the invention uses software “objects” to represent PoC Orders. These objects are components (entities) of a software program, such as an icon, command button, text box, etc., which can be manipulated with a mouse (e.g., click and “drag and drop”). The terms class, inheritance, and attributes define aspects of the objects representing the Orders in a PoC:
PoC Class. The class of objects representing the Orders of a PoC consists of a collection of similar objects with shared structure (attributes) and behavior (methods). All objects in the PoC class share the same structure and respond to the same messages. The PoC class acts as a “storage bin” for similar objects (see Database Systems, Rob & Cornel, Course Technology-Thomson Learning, 2000, ISBN 0-7600-1090-0). The objects in the same class exhibit the property of inheritance and have attributes that present the object's characteristics.
Inheritance. Each Order inherits the ability, data structure and behavior (methods) of the class PoC.
Attributes. Orders have attributes, known as instance variables. That is, each Order's object inherits its PoC's attributes, which may include, for example, the name of the CP or PG from which the PoC is comprised, as well as patient name, social security number, diagnosis, and/or other pertinent information.

E. Information Model

The inventions information model includes definitions for all inputs and output specifications associated with its processes. This information model provides a view into how the processes communicate with each other.

III. Prior Art Related to the Five Core Healthcare Processes

Following are references to prior art related to the aforedescribed five core healthcare processes relevant to the invention.

A. Generating and Updating a Plan-of-Care (PoC)

The prior art contains many different computerized systems for generating and modifying PoCs. They include systems for the following:
U.S. Pat. No. 6,434,531 to Lancelot, Burford, and Urquhart (2002) discloses a software system utilizing templates of pre-defined clinical pathway type PoCs, assigning a template to a given patient undergoing treatment that is tailored for the requirements of the patient, and tracks variances from the PoC.
U.S. Pat. No. 6,401,072 to Haudenschild, Lancelot, and Urquhart (2002) discloses a software system that assists healthcare providers in generating clinical pathway PoCs where multiple diagnoses exist.
U.S. Pat. No. 5,583,758 to Mcllroy, Kees, and Kalscheuer (1996) discloses a software system that generates PoCs from a database of diagnosis-based practice guidelines and track variances between recommended Orders and the ones actually delivered.
U.S. Pat. No. 5,072,383 to Brimm, Diaz, Fein, Norden-Paul, Stern, and Stewart (1991) discloses a software system that generates time-oriented PoCs and a record of completed Orders
U.S. Pat. No. 5,786,816 to Macrae, Ting, Ho, Edholm, Matsumoto, Sigmon and Worth (1998) discloses a software system that visually depicts Orders using a graphical user interface

B. Managing Resources

Another important process in healthcare delivery is the allocation, utilization and consumption of resources such as labor, durable equipment, reusable supplies and disposable supplies. Each Order in a PoC represents the provision of some type of service and the allocation of some type of resources, such as labor (doctor, nurse, technician, data clerk, etc.), equipment (x-ray machine, respirator, vital signs monitors, etc.), beds and rooms, or supplies (sponges, surgical instruments, drapes, x-ray film, sutures, medications, etc.). Thus, for each Order it is possible to identify the allocation of resources necessary for completion of the Order.

Computerized resource management systems currently exist for the following:
U.S. Pat. No. to 5,991,728 to DeBusk, Shanks, and Cofer (1999) discloses a software system that tracks and analyzes medical supply usage in a healthcare facility and providing historical record keeping.
U.S. Pat. No. 6,314,556 to DeBusk, Cofer, Shanks and Lukens (2001) discloses a software system that represents specific events and resources which will occur or be utilized during the execution of a PoC, which enable the tracking of care delivery, the utilization of resources during the delivery of care, the allocation of resources to perform medical procedures and identify opportunities for enhancing efficiencies in care delivery.
U.S. Pat. No. 7,003,475 to Friedland, Lai, Wood and Chen (2006); U.S. Pat. No. 5,111,391 to Fields, Quinn and Blackley (1992); U.S. Pat. No. 5,943,652 to Sisley and Collins (1999); and U.S. Pat. No. 5,596,502 to Koski, Henderson and Barlow (1997) disclose software systems for scheduling labor, beds and equipment, which includes doing real-time scheduling that accounts for both known and unknown variables that produce bottlenecks and resource shortages.
U.S. Pat. No. 5,842,173 to Strum and Vargas (1998) discloses as software system that tracks, disseminates and analyzes site-specific information related to the work process in other units of surgical services, so that scheduling and resource allocation decisions are based on accurate, instantaneous appreciation of the overall situation to improve coordination of personnel, space, and equipment.

C. Guiding PoC Selection and Execution

In addition to generating a PoC and managing the requisite resources, a third healthcare process involves selecting appropriate interventions and guiding the delivery of the planned care through rule-driven alerts and reminders about how and when to execute the PoC's Orders. U.S. Pat. No. 5,740,800 to Hendrickson and Stern (1998) discloses a software system that selects clinical pathways based on a patient's condition, U.S. Pat. No. 5,946,659 to Lancelot, Burford and Gardner (1999) discloses a software system that guides PoC execution as a clinical pathway, and U.S. Pat. No. 6,786,406 to Maningas (2004) discloses a software system for using clinical pathways in hospital emergency departments.

D. Tracking and Reporting Variances

When a PoC is being executed, it is useful to track variances, i.e., departures from the recommended interventions, in order to better understand and improve care delivery. U.S. Pat. No. 5,946,659 to Lancelot, Burford and Gardner (1999) and U.S. Pat. No. 6,434,531 to Lancelot, Burford and Urquhart (2002) disclose software systems that track the variance data.

E. Tracking, Analyzing and Reporting Outcomes

Finally, it is important to track, analyze and report the clinical and financial outcomes (results) of the care delivered in order to know the effectiveness of the interventions delivered, so adjustments may be made in the PoC and healthcare delivery system to improve care quality and efficiency. U.S. Pat. No. 6,108,635 to Herren, Fink, Kornman, Moehle and Moore (2000) and U.S. Pat. No. 5,435,324 to Brill (1995) disclose software systems that that manage such outcomes.

IV. Disadvantages of the Prior Art

No prior art combines the five aforedescribed core healthcare processes into a single software system that generates a PoC through the selection of a practice guideline or clinical pathway, manages the resources required to execute the PoC successfully, guides PoC implementation, tracks and reports variances from the PoC, and tracks and reports the outcomes of care delivered. Nor does the prior art track and report the reasons for the variances.

V. Prior Public Disclosure

On Apr. 4, 2006, we publicly disclosed the following brief and incomplete description of a technology that promotes care quality by:
monitoring plan of care execution and alerts clinicians when orders are not carried out in a timely manner, enabling adjustments to be made in the care plan so as to avoid adverse events;
enabling the efficient allocation of time and hospital resources by helping assure plans of care are carried out as ordered with minimal disruption by tracking each procedure for every patient, computing resource requirements against current capacities, and providing staff real-time information needed to accommodate all plan of care orders in a timely manner; and
working in conjunction with EHR, CPOE, and clinical pathways tools to provide the “brains” that analyze clinical data using rules and to making decisions about plan of care execution, and by triggering a process by which clinicians working with the patient are notified in a timely manner about the situation, and given the information they need to rectify the problem.

While this prior public disclosure describes some of the basic functionality of the present invention, it does not disclose any of the details about the components and processes the present invention utilizes to perform those functionalities, such as the CEM Rules Base, queues, warning and alert logic, data collection methods, and resource need and availability computation methods. Nor does the prior public disclosure reflect any of following functionalities of the present invention:
establishing patients' PoCs;
identifying healthcare facilities having adequate resources to execute patient's PoCs;
notifying authorized users when resource shortages currently exist or are projected;
enabling resources to be increased or PoCs to be adjusted in order to account for resource shortages;
notifying authorized users of the execution status of PoC Orders;
alerting authorized users when early or late Order execution, or dropping (not executing) an Order, is likely to cause problems in the care of a one or a plurality of patients;
assisting authorized users in adjusting any Orders parameters (attributes) that might cause a problem if executed, so as to prevent problems from occurring; and
generating reports showing healthcare delivery performance and giving insight into ways to improve the performance.

### OBJECT AND ADVANTAGES

Accordingly, the objects and advantages of the invention involve the provision of a software system that handles ten core healthcare processes required for:
(1) establishing patients' PoCs;
(2) evaluating required against available resources;
(3) identifying healthcare facilities having adequate resources to execute patient's PoCs;
(4) notifying authorized users when resource shortages currently exist or are projected;
(5) enabling resources to be increased or PoCs to be adjusted in order to account for resource shortages;
(6) tracking the execution status of PoC Orders, including when particular Orders are due for execution, are late, have been executed on time, have been executed early, have been executed late, or are not being executed;
(7) notifying authorized users of the execution status of PoC Orders;
(8) alerting authorized users when early or late Order execution, or dropping (not executing) an Order, is likely to cause problems in the care of a one or a plurality of patients;
(9) assisting authorized users in adjusting any Orders parameters (attributes) that might cause a problem if executed, so as to prevent problems from occurring; and
(10) generating reports showing healthcare delivery performance and giving insight into ways to improve the performance.

One advantage of managing these core processes through a single integrated software system, as opposed to using multiple disparate systems, is convenience and ease of use. Another advantage is the comprehensive information supplied by the invention, which helps improve the delivery of care by:
guiding the implementation (execution) of recommended interventions;
making certain that the required resources are available or that PoCs are adjusted to accommodate resource shortages;
assuring care is implemented in a timely manner or appropriate adjustments are made to PoCs to avoid problems with early, late or dropped Orders; and
supporting research that studies variances and reasons for the variances, as well as clinical and financial outcomes, so that care delivery problems are identified and opportunities to improve care quality and efficiency are understood.

Still further objects and advantages will become apparent from a consideration of the ensuing descriptions and drawings.

### DRAWINGS FIGURES

In the Drawings:

FIG. 1 illustrates a block diagram of the apparatus of the invention;

FIG. 2 illustrates an operational flow diagram of the software applications utilized by the invention;

FIG. 3 is a flowchart illustrating PoC Order execution monitoring, tracking, and alerting;

FIG. 4 is a flowchart illustrating PoC Order execution timing-related processes;

FIG. 5 is a flowchart illustrating the resource availability queuing processes; and

FIG. 6 is a Microsoft Excel spreadsheet illustrating a method for evaluating the availability of a medication resource.

### REFERENCE NUMERALS IN DRAWINGS

| | |
|---|---|
| 1 | Computer Apparatus |
| 2 | CPU |
| 3 | ROM device |
| 4 | RAM device |
| 5 | Input device |
| 6 | Presentation device |
| 7 | Output device |
| 8 | Storage device |
| 9 | Backup system |
| 10 | User interactive interface device |
| 20a | EHR application |
| 20b | EHR Database |
| 22a | HIMS application |
| 22b | HIMS Database |
| 24a | CPOE application |
| 24b | CPOE Database |
| 26a | CPG/CCP application |
| 26b | CPG/CCP Database |
| 28a | Care Executive Management (CEM) |
| | application |
| 28b | CEM Rules Base (CEM-RB) |
| 29 | Resources Databases (or a combined |
| | Resource Database with tables for each resource |
| | type) |
| 29a | Inventory Database (or Inventory table in a |
| | combined Resource Database) |
| 29b | Space Database (or Space table in a |
| | combined Resource Database) |
| 29c | Staff Database (or Staff table in a combined |
| | Resource Database) |
| 29d | Environment Database (or Environment |
| | table in a combined Resource Database) |
| 504 | Resources Needed Queue |
| 506 | In-Process Queue |
| 512 | Active Queue |
| 514 | Complete Queue |
| 516 | Idle Queue |

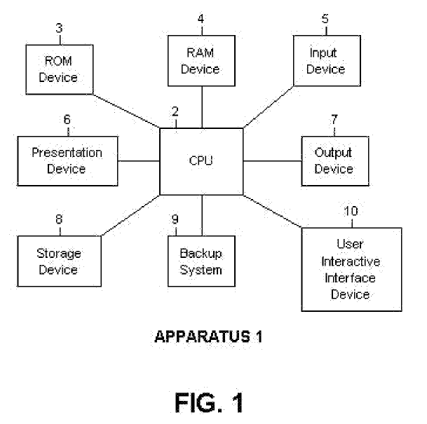

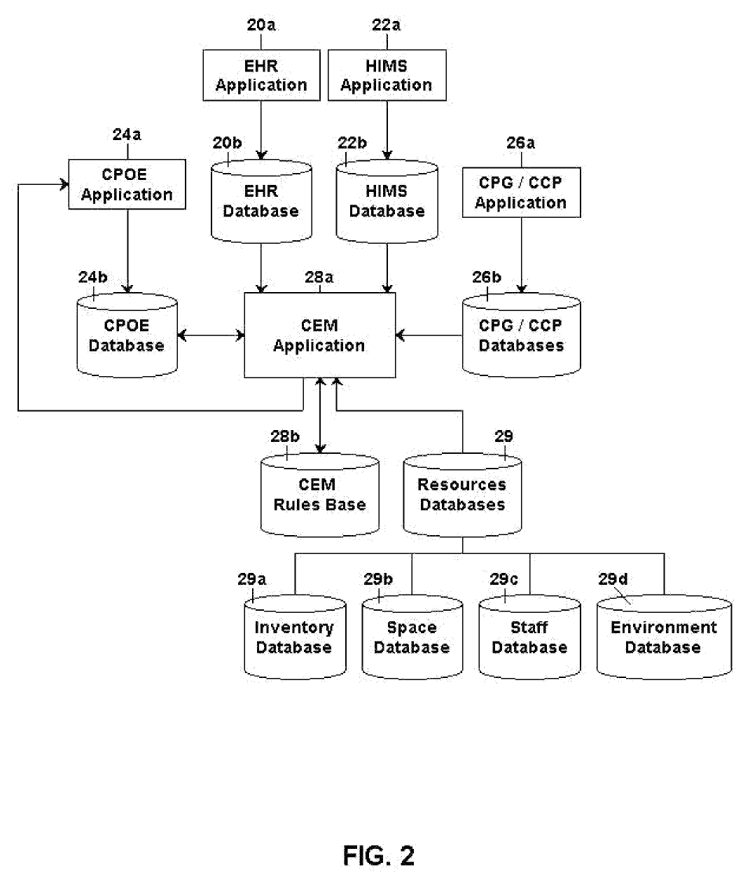

### Description: FIGS. 1-2

I. CEM Apparatus

FIG. 1 illustrates a block diagram of the CEM apparatus of the invention which is denoted generally by the reference numeral 1. The apparatus of the invention is comprised of a Central Processing Unit (CPU) 2 which is utilized for obtaining, processing, and reporting at least one element (unit) of data and information. The CPU 2 may operate in a microprocessor, a microcomputer, a mainframe computer, a supercomputer system, or a molecular computer depending upon the application and the digital computer system employed.

The apparatus 1 is also comprised of a Read Only Memory (ROM) device 3 for the storage of the operational program data or codes which control the operation of the apparatus and which is further comprised of any additional software programs or codes which direct the apparatus 1 to perform the method utilized in the invention. In this manner, the method of the invention may be embodied solely as a computer and/or software program or codes. A Random Access Memory (RAM) device 4 is also utilized for storing the data and information, which will be described in more detail below. Note that any other suitable memory method may also be used such as PROM, EPROM, and “bubble memory”. An input device 5 is utilized in the apparatus 1, which may be a keyboard, mouse, joy stick, optical scanner, electronic pen, modem, magnetic strip reader, LAN device, WAN device, touch screen, camera, touch pad, biologic measurement device, microphone, infrared device, ultrasound device or any other suitable means for entering data, information and user control commands into a digital computer system.

The apparatus 1 is also comprised of a user presentation device 6 for presenting information related to the operation of the invention. In this respect, the operation of the apparatus 1 may be facilitated by the display of on-screen menus, the sounding of audio speakers, and any other suitable means which may allow a user, via the user input device 5, to select apparatus operations or in other ways exert control over the invention. The presentation device 6 may also present requests for input information and/or data to the user in text, graphics, audio, video, multimedia, and any other suitable formats.

The apparatus 1 is further comprised of an output device 7 which may be or which may include a printer and plotter for generating output data and information such as hard copy reports, an amplifier and speaker for generating audio representations of the data and information, a modem or other suitable telecommunication means for electronically transmitting output data and information or report data and information to remote locations, and other suitable output means for presenting data and information. The presentation device 6 may also function as an output device 7 by displaying a visual, audio, and any other suitable presentation of output data and information.

The apparatus 1 is further comprised of storage device 8 which is made up of a hard disk, floppy disk, compact disk, magneto-optical drive, tape drive, magnetic strip, or other suitable means is used for storage of data and information in digital form.

The apparatus 1 may also comprise a backup system 9 which is made up of a CPU 2′, a ROM device 3′, a RAM device 4′, and storage device 8′, which are identical to the CPU 1, the RAM device 4, the ROM device 3, and storage device 8, respectively, described above. The backup system 9 serves as a redundancy system in the event of a failure or malfunction of any of their primary system counterparts (CPU 2, ROM device 3 and RAM device 4, and storage device 8, respectively). In this manner, duplicate files may be stored.

The apparatus 1 may also comprise a user interactive interface and delivery system 10. The user interactive interface and delivery system 10 may be a separate computer (not shown) which may contain ROM and RAM memory devices, data input and user command entry devices, which may include a keyboard, a mouse, and/or a modem or any other suitable device, and a data output device which may be a printer or any other suitable device for obtaining, receiving or storing data output reports. The user interactive interface and delivery system 10 is designed to be utilized by remote users and is further designed to be located at remote locations such as at the locations of the above described users. The user interactive interface and delivery device 10, may be interfaced with the apparatus 1 of the invention either via telecommunication means and/or other suitable communication networks which may include direct communication link-ups and/or radio communication link-ups via transmitting and/or satellite communication systems or means.

The user interactive interface and delivery device 10 provides a means by which to allow a remote user, as defined above, to access the apparatus 1. This may allow for a direct transmission of data and information to be entered via any suitable data entry means located at the user's location. It should be noted that adequate precautions are to be taken so as to prevent a nonauthorized user from accessing the apparatus 1 and the data, information, or algorithms stored therein. Any informational reports, if desired, may be electronically transmitted to the user via the user interactive interface and delivery device 10 wherein the report or reports may be output via the output means (not shown), which may be a printer or other suitable output device, or wherein the report data may be stored in a user memory device.

Utilization of the user interactive interface and delivery system 10 in FIG. 1 may be accompanied by a security scheme or means whereby the user may be required to input a user password or access code so that accessing the system and/or decrypt data and information that has been previously encrypted is enabled. Any other suitable security system may also be utilized to safeguard the apparatus 1 of the invention as well as a user's files and/or other interests. The security scheme or means may also be provided to ensure security and confidentiality of data and information. Further, the device 10 allows for an expedited data and information entry process as the data and information may be entered directly and/or instantaneously into the apparatus 1.

Further, the apparatus 1 of the invention may be adapted to service multiple users over multiple channels in a network environment such as in local area networks (LANS) as well as wide area networks (WANS) wherein the invention may be utilized over communications and/or long distance communication lines or systems such as telephone networks (phone lines) and/or radio communication and/or satellite communication networks.

Further, the user interactive interface and delivery system 10 may be employed to allow a user access to unsecured databases, or portions thereof, which may be stored in the apparatus 1 or which may be used in association with the invention. The user interactive interface and delivery device 10 therefore may also provide for a means by which the invention may be utilized as an on-line database. In this manner it can be seen that the invention, which may be utilized in conjunction with network systems described above, can be utilized for providing vast amounts and varieties of data and information.

The CPU 2 operates under the control of the system operational software which is stored in the ROM device 3 memory device. The operational software of the apparatus 1, as will be described in more detail below, provides for complete control over the operation of the method of the invention. The operational software may be provided in any programming language or it may be implemented in assembly or assembler language for the particular microprocessor or CPU utilized, depending upon the digital computer or processor utilized as well as depending upon any of the specific application constraints.

II. CEM Application and Database

In the preferred embodiment of the invention, a CEM application 28a retrieves data from any of the group of HIT application databases including one or more EHR 20b, HIMS 22b, CPOE 24b, and CPG or CCP 26b Databases as indicated by the corresponding arrows. Or, in an alternate embodiment, a CEM application 28a retrieves the data from other data stores (i.e., other devices or formats in which the data are stored, such as XML files, flat files, delimited text files, other text files, etc.). The CEM application 28a also retrieves data from a plurality of facility's Resources Databases 29—in which data about equipment and supplies in the Inventory Database 29a, rooms in the Space Database 29b, staff availability in the Staff Database 29c and Environment Database 29d are stored—as indicated by the corresponding arrows. In addition, the CEM application 28a sends information to and retrieves information from a CEM Rules Base (CEM-RB) 28b, which is created when the CEM is developed and may be modified or updated at any time via the CEM application UI 28a. The CEM-RB 28b may be comprised of one or more programming code modules, databases, spreadsheets, flat files and/or other means within which resides at least one computer-based algorithm consisting of a finite set of well-defined instructions implemented by a computer as mathematical functions (computations) or procedural methods (routines). Utilizing the rules (i.e., algorithms) in its CEM-RB 28b, the CEM application 28a processes the patient, treatment, and resources data from the aforedescribed databases 20b, 24b, 26b and 29, and/or other storage means.

III. HIT Software Applications Utilized

FIG. 2 is a diagram illustrating the required and optional HIT software applications utilized by the invention, which are integrated into a single system. This system streamlines certain PoC processes; provides decision support; gives timely feedback to healthcare workers when certain processes are failing; enables the failing processes to be remedied; and tracks and reports key information about care delivery and outcomes.

In the preferred embodiment of the invention, patient and healthcare treatment data necessary for establishing a PoC and tracking its execution are input through any or all of the following:
EHR application 20a and are stored its EHR Database 20b, as indicated by the corresponding arrow;
HIMS application 22a and are stored its HIMS Database 22b, as indicated by the corresponding arrow;
CPOE application 24a and are stored its CPOE Database 24b, as indicated by the corresponding arrow; and
CPG or CCP application 26a and are stored its CPG or CCP Database 26b, as indicated by the corresponding arrow.

In an alternate embodiment, the data input and storage functions of any or all EHR, HIMS, CPOE, CPG and CCP applications may be implemented by different types of applications that enable the necessary patient and healthcare treatment data to be stored and accessed. Instead of using an EHR, another application having a patient data input, retrieval, and display means may be used. Instead of using an HIMS, another application may be used for capturing, classifying, and operationalizing healthcare data. Instead of a CPOE, another application having an Order input, retrieval, and display means may be used. And instead of using CPG or CCP applications, other means of inputting and accessing PGs or CPs may be utilized.

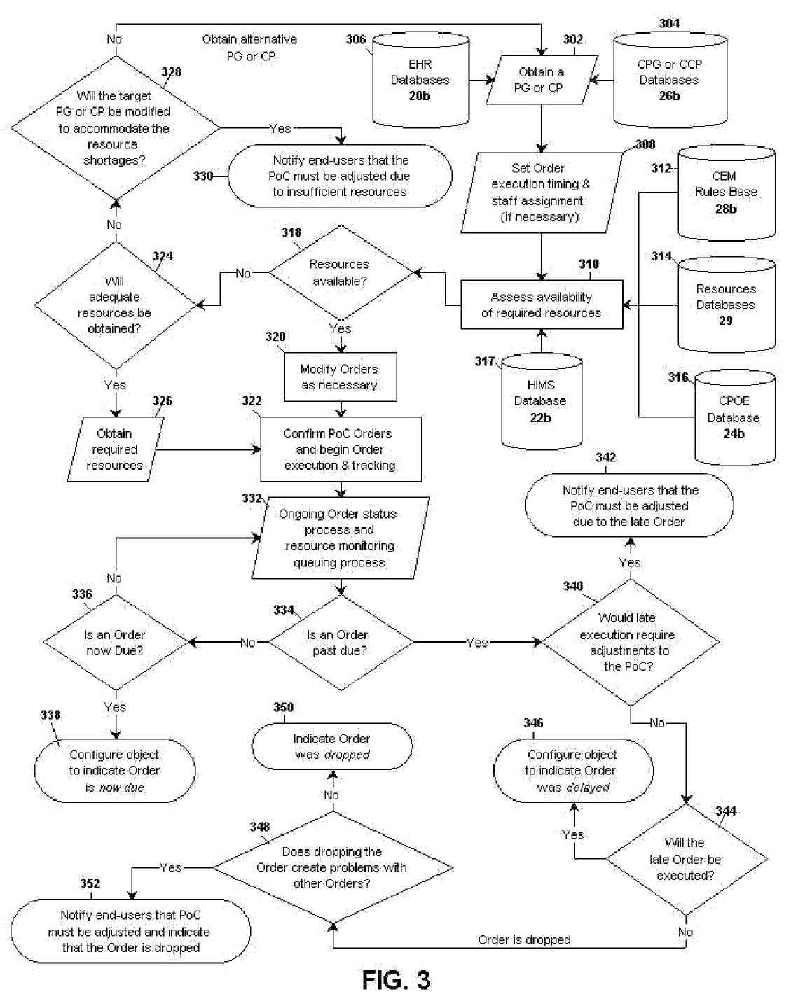

Management of the PoC Order execution utilizing the CEM apparatus 1, CEM application 28a, CEM-RB 28b, and HIT applications and data stores as described in the operations section described below with reference to FIGS. 3 through 5.

### Operation: FIGS. 3-6

I. Overview of CEM PoC Management Functions

In the preferred embodiment of the invention, each PoC Order is represented by an object. These objects exhibit the property of inheritance and have attributes that represent an object's characteristics. Each Order requires certain resources (e.g., staff, supplies, beds) to be executed properly. Orders may also have timeframes or sequences within which they must be executed. Thus, the object representing an Order inherits the attribute of resource requirements and possibly an execution timeframe or sequence attribute, as well as clinical (e.g., patient health-related), administrative (e.g., insurance claims), and other relevant information.

The CEM 28a manages constraints related to the generation and execution of each PoC Order by using computerized rules (algorithms) and working in conjunction with EHRs, HIMS, CPOEs, and CPGs or CCPs in the preferred embodiment, and/or working in conjunction with other software applications providing similar functionality in an alternate embodiment. The CEM 28a can utilize any suitable programming (software) code in any programming language that enables it to perform its functions. For any number of patients, the CEM 28a:
Monitors PoC execution and alerts authorized individuals when Orders are due for execution or are late, when Orders are not carried out in a timely manner, and when there are disruptions with Order execution, thereby enabling adjustments to be made in the care plan to avoid adverse events; and
Enables the efficient allocation of time and hospital resources by tracking each PoC Order and computing resource requirements against current capacities on an ongoing basis, and by supplying information authorized users need to accommodate execution of the Orders in a timely manner.

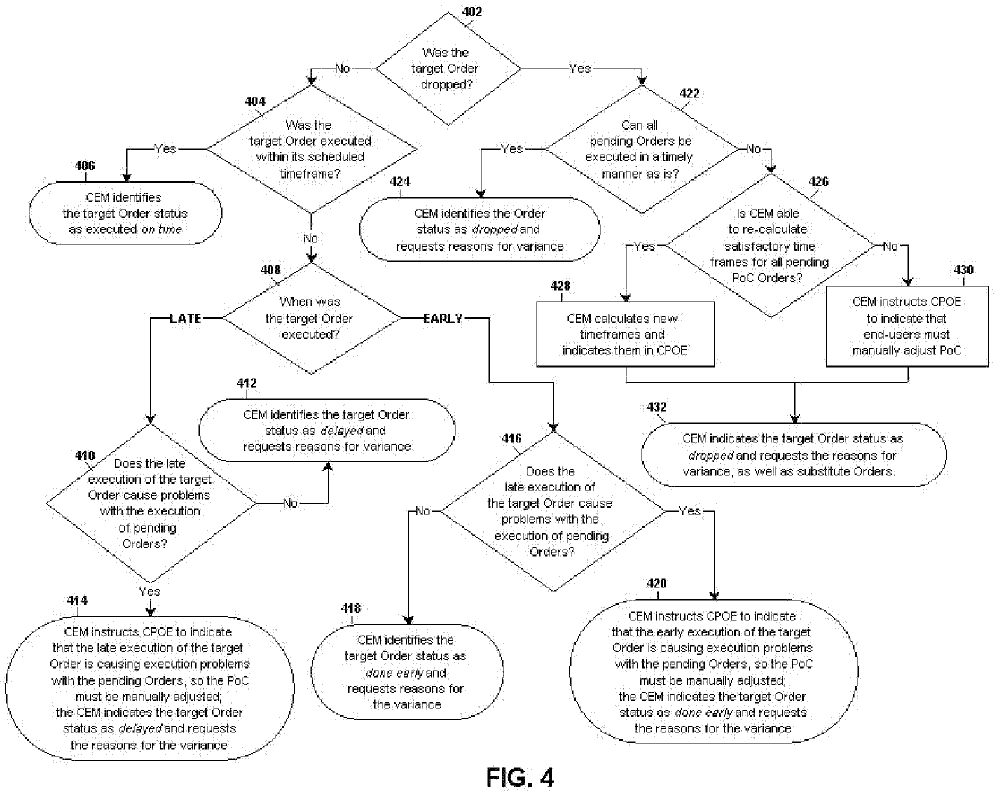

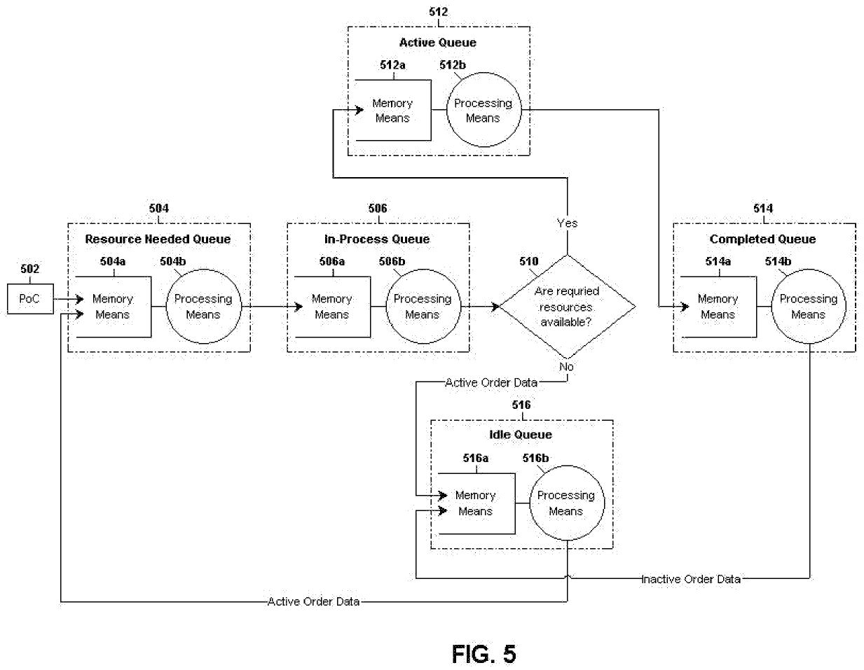

Three figures illustrate the CEM's PoC management functions. FIG. 3 is a flowchart illustrating the PoC Order execution monitoring, tracking, and alerting process. FIG. 4 is a flowchart illustrating PoC Order execution timing-related processes. FIG. 5 is a flowchart illustrating the resource availability queuing processes.

II. Establishing a PoC

The process for establishing a PoC begins upon user request or it may be initiated via any other suitable trigger. User request for a PoC to be established can be done through programming code in an EHR 20a, CPOE 24a, HIMS 22a, CEM 28a or other application that triggers execution of the PG or CP retrieval process, which is described below. The execution of the PG or CP retrieval process may be initiated based on manual user input, particular changes occurring to particular databases, and other suitable triggers. For example, the CEM 28a may be instructed to execute the PG or CP retrieval process through programming code initiated by a user via an EHR UI 20a, the CEM UI 28a, the UI of a different application. The CEM 28a may also execute the PG or CP retrieval process automatically if, for example, it is configured to query the EHR Database 20b continuously according to a pre-established schedule (e.g., every 5 minutes) and evaluate whether patient data has been entered into the EHR Database 20b, which would indicate PG or CP selection is required.

Following is an example (the “Insulin Adjustment PoC” example) of some of the information contained in the Orders of a possible PoC for a single day of hospitalization to manage a patient's insulin level:
1. Monitor vital signs at 8 AM±30 min—nursing staff
2. Serve breakfast at 8 AM±30 minutes and measure caloric meal content consumed
3. Administer medication at 8 AM±30 min—nursing staff
4. Draw blood 2 hours after completing breakfast—nursing staff and laboratory
5. Serve high carbohydrate lunch at 12 PM±10 min and measure caloric meal content consumed
6. Monitor vital signs at 2 hours after lunch ±30 min—nursing staff
7. Draw blood 2 hours after lunch—nursing staff; laboratory performs laboratory analysis
8. Discuss blood test results at 5 PM±30 min—physician & nursing staff
9. Set insulin level at 6 PM±30 min—update plan-of-care to reflect insulin value
10. Pharmacy delivers insulin at 7 PM±30 min—inventory database is updated
11. Monitor vital signs at 8 PM±30 min—nursing staff
12. Dispense insulin at 8 PM±15 min—nursing staff
13. Serve dinner at immediately after dispensing insulin and measure caloric meal content consumed
14. Draw blood 2 hours after dinner—nursing staff; laboratory performs laboratory analysis
15. Do rounds at 6 AM±30 min—observation and clinical assessment

Note that such a PoC could also include Orders for monitoring and responding to signs and symptoms, such as tracking polyuria, polydipsia, and intense thirst every 15 minutes; monitoring ECG for signs of hypokalemia; recording patient's weight each morning; etc.

III. Self-Adjusting PoCs Based on Diagnostic Assessment Data

The Orders of some PoCs may change periodically based on the results of ongoing diagnostic assessments. The diagnostic data is entered manually into the CEM 28a, an EHR 20a, and/or a CPOE 24a via a UI and stored in the appropriate database. In addition, the diagnostic data may input automatically using sensors connected to diagnostic equipment. The CEM 28a then examines the diagnostic data based on algorithms stored in the CEM-RB 28b that are associated with each PoC Order's OI. If the diagnostic data crosses a threshold defined in the CEM-RB or Order's OI (e.g., if a lab test result exceeds a predetermined level), then the CEM CEM 28a automatically adjusts the PoC by substituting one or more new Orders, or by modifying at least one attribute of at least one existing Order, and then notifying authorized users of the changes and requesting confirmation, as described later.

IV. Retrieving a PG or CP

Referring to FIG. 3, at step 302, the CEM 28a retrieves one or more appropriate (“target”) PGs or CPs from the CPG or CCP Databases 26b, or from other data stores, using any suitable database queries or other computerized methods of data retrieval. A plurality of methods may be used for selecting a PG or CP; for example:
The CEM UI (FIG. 1 block 10) may be used to manually select from an electronic list.
A manual data input means may be used to enter the Orders comprising a PG or CP directly into the CEM apparatus 1.
Diagnostically-relevant patient data retrieved from one or more EHR Databases 20b may be used to map a patient's condition and needs to particular PGs or CPs. This mapping process would enable the CEM 28a to filter out inappropriate PGs or CPs, so that only appropriate ones for a particular patient are recommended for selection. This can be done, for example, by assigning meta-data to each PG and CP from the group consisting of diagnostic codes, symptoms, demographics, and other relevant data. The CEM 28a can then automatically select appropriate PGs or CPs by matching the meta-data to a patient's EHR data, or the CEM can allow the end-user to select a PG or CP from a filtered list. In this way, the CEM provides decision support capabilities for selecting PGs or CPs.

V. Setting Order Timing and Staff Assignment

A. Establishing Order Timing

The timing of an Order's execution may be independent of other events (e.g., draw blood at 8 AM±30 minutes), or it may be dependent on other events (e.g., draw blood 2 hours after eating). That is, Orders can be executed based on different timeframes, including:
(a) an event-driven basis (e.g., do Order C if Order A cannot be executed, or do Order B after Order A is completed);
(b) a relative time basis (e.g., do Order B within an hour of executing Order A); or
(c) a discrete time basis (e.g., do Order A between 1 and 2 PM).

The Order timeframes may be established by authorized users when the Order information (OI) of each Order in a PG or CP is created. For any Orders selected as part of a patient's PoC, which have associated data designating event-driven and relative times for the Order execution, the CEM 28a may automatically use the time data of previous Orders to calculate the timeframes for any subsequent Orders and send the time data to the CPOE Database 24b (or other data store) to be confirmed by the user via a CPOE UI 24a or another application UI.

B. Handling Order Timing Conflicts

As each Order's timing is established, the CEM 28a evaluates the timing against the timings of all other Orders for all other patients in a facility. The CEM then notifies authorized users when an Order's timeframe conflicts with any other Order. This can happen, for example, if an Order is being established that calls for medications to be given at a time when it is physically impossible for staff to execute the Order because the number of other patients are scheduled to have Orders executed at the same time are greater than the number of staff available to carry out the Orders.

Step 308 (FIG. 3) is an optional step in which any OI from one or more target PGs or CPs that are missing data or require data modification are input via the CPOE UI 24a or other application's UI.

C. Assigning Staff to Orders

Many different methods can be use to assign staff to Orders. Examples include, but are not limited to the following:
Staff assignment can be input or modified by having authorized users select staff from a list created as the CEM 28a queries the Staff Database 29c.
The CEM 28a can use algorithms in its Rules Base 28b about staff roles that are associated with Orders to select staff names from the Staff Database 29c and submit the names for confirmation by authorized users via the CPOE UI 24a or other means.

Order timeframes can also be input by authorized users via the CPOE UI 24a or other means.

D. Modifying Staff Assignments and Orders Timing

If the staff assignments or Order timeframes have been previously established, they may be manually modified by authorized users at step 308.

VI. Initial Resource Management Processes

Two processes manage resource utilization. The first (initial) process occurs when a PoC is being established, which will now be described. The second process occurs once the PoC is being executed, which will be described later.

A. Determining Resource Availability

At step 310, once one or more appropriate PGs or CPs are retrieved by the CEM 28a, it determines if the necessary resources are available to execute the PGs or CPs in a timely manner and, if not, alerts authorized users of any resource shortages.

When making resource availability determinations, the CEM uses rules in its Rules Base 312 and accesses resource utilization data from the facility's Resource Database 314, queues (which are described later with reference to FIG. 5), or both. The same process repeats whenever a PoC is modified.

At step 318, a determination is made whether the requisite resource are available. In the preferred embodiment of the invention, this resource determination process utilizes both database queries and resource queuing processes by which resources-needed and resources-available data are obtained by the CEM 28a for analysis; in an alternate embodiment, either may be used. The queuing process is described later. The following describes the Resource Databases 29 and the database query process.

B. Resource Databases

Resource Databases 29 at step 314 (FIG. 3) may be comprised of one or more databases containing one or more tables storing data about the availability of the relevant resources. In the preferred embodiment of the invention, the following four categories of resources are included, although other categories may be used in alternate embodiments:
Inventory, which refers to the availability of medical equipment such as X-ray and dialysis machines; medications; materials such as bandages, surgical knives, plasma; etc.
Space, which refers to the availability of patient rooms, operating rooms, recovery rooms; as well as hallways and other non-patient spaces, because they could be allocated in the case of a catastrophic emergency where traversal times could affect patient care. Each of these locations contains various resources like an X-Ray machine, a lab, oxygen, and beds, which would typically be allocated with the room itself.
Staff, which refers to several classes of people with different roles, responsibilities, and competencies. In a typical hospital, there is a staff access hierarchy, i.e., staff is allocated on a day to day basis with the expected quality expectation that a certain number of staff can handle a certain amount of PoC Orders. For example, a rule of thumb may be that in an ICU (intensive care unit), a single ICU nurse may handle no more than three ICU patients, hence three PoCs, per shift. The total number of nurse required, therefore, would be the total number of ICU patients divided by 3. However, this number could go higher in an emergency situation where a large number of patients enter the ICU in close time proximity, which would require additional staff to be reallocated to the ICU. In Order to prevent the reallocation of staff from other units in which they are needed to carry out their respective Orders, staff may be accessed from a reserve pool, if any exists. In addition, an emergency may require that a nurse handle more than three patients.
Environment, which refers to the basic needs to sustain life in an emergency, which may include sustainable electricity, heat, light, water, food stuffs, cloths, refrigeration, sustainable communications, sustainable air and oxygen, fuel, transport, adequate management and disposal of waste, security, etc.

In addition to tracking current resource availability, the Resource Databases 20b at step 314, or other databases, may include fields that track resource availability on an hourly, daily or other time basis into the future. For example, particular database fields may contain projected medication amounts for each day through a future date based on estimated medication usage of all patients currently being tracked by the invention.

C. Query Resource Databases

The CEM 28a may query the Resource Databases 29 at step 314 on a preset time basis (e.g., every 5 minutes) and/or as is otherwise necessary to determine if required resources are available. Any suitable programming code executes the query process and returns the data from the database queries to the CEM application's memory means 4, which may include use of a spreadsheet and/or other electronic means.

D. Access Queues

The CEM 28a may access certain queues that store resource data, which may be more up-to-date than the Resource Databases 29. This queuing process is described later.

E. Compare Resource Requirements to Available Resources

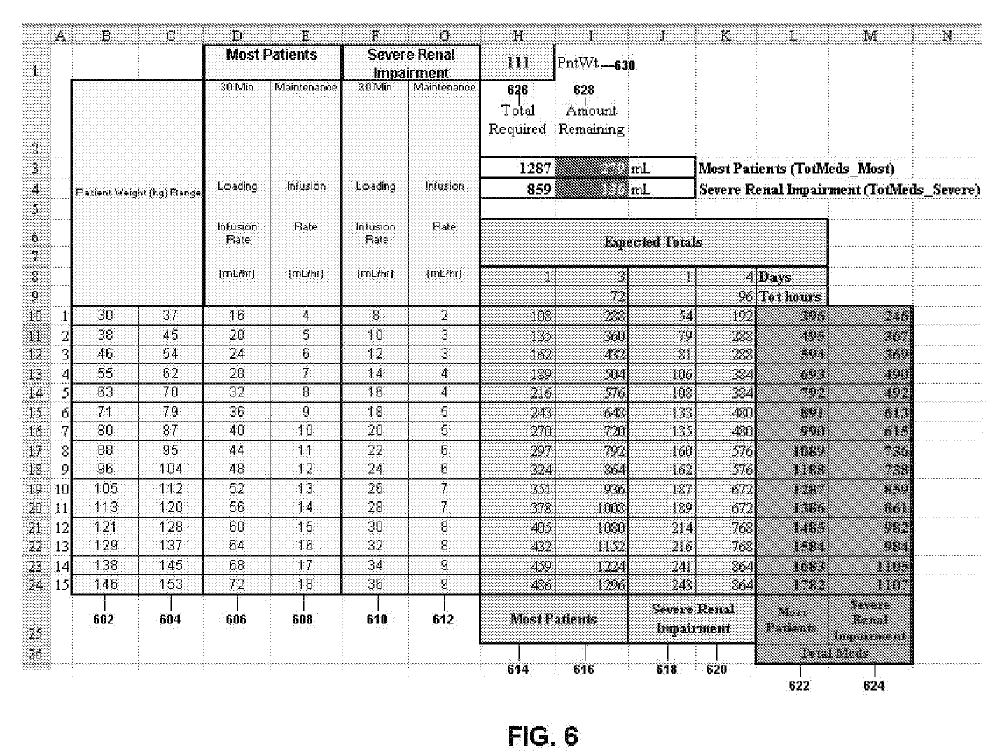

Once the resource data are queried and stored in CEM apparatus's memory means 4, the CEM 28a accesses specific algorithms from its Rules Base 28b, which it uses to compare resource requirements to available resources. Any suitable method can be utilized by which the algorithms are used to compare required resources to available resources. Following is an example of such a comparison method, depicted in FIG. 6, which is based on the CEM's use of Microsoft Excel spreadsheets to evaluate the availability of a medication Order defined in a medication Order's OI.
The process begins as the CEM's 28a programming code retrieves a spreadsheet containing an array of data showing the recommended dosage of the medication.
The particular spreadsheet retrieved by the CEM 28a is determined by certain contents of the medication Order's OI. The array has six columns that correspond to the patient weight range.
The first column, notated with the reference numeral 602, contains values for the smaller weight and the second column 604 contains values for the larger weight within each range. The third column 606 contains the recommended 30 minute loading infusion rate in mL/hr, which is the amount prescribed for the first half hours, and the fourth column 608 contains the recommended maintenance infusion rate in mL/hr. The fifth column 610 and sixth column 612 contain the same data as the third and fourth columns (606 and 608), except that the infusion rates in the third and forth columns are for most patients, while the latter two columns (610 and 612) are for patients with severe renal impairment. The infusion rates on each spreadsheet row (10 through 24) in these columns correspond to the different weight ranges.
A second set of six columns 614 through 624, which correspond to the six aforedescribed first set of columns, contain formula in their cells that compute the expected total amount of medication required for the patient's entire estimated length of treatment. Using the OI that designates the estimated number of days of treatment required, formulas in the cells of the first column 614 compute the total mL of medication necessary the first day of treatment and formulas the second column 616 compute the total mL required for all remaining estimated days of treatment. The third column 618 and fourth column 620 contain the same data as the second 616 and third 618, except that the infusion rates in the third 614 and forth 616 columns are for most patients, while the latter two columns (618 and 620) are for patients with severe renal impairment. The fifth column (622) and sixth column (624) calculates the amount of medication needed for a patient's entire estimated length of treatment based on patient weight, with the amount for most patient in column five (622) and severe renal impairment in column six (624).
Another pair of cells 626 contains formulas that find and display the actual patient's total medication requirements based on the patient's weight and renal impairment severity for the entire estimated length of stay. In the preferred embodiment of the invention, the patient's weight (in the cell the reference numeral 630) and renal impairment severity information would have been obtained when the CEM queried the EHR Database 20b at step 306 in FIG. 3. In alternate embodiments, the weight and renal impairment severity data could have be retrieved from other data stores or be input manually into the CEM apparatus's UI 10.
Still another pair of cells 628 contains data indicating the total mLs of medication required for the patient's remaining length of stay. In the preferred embodiment of the invention, the total mLs of medication available would have been obtained when the CEM queried the Resources Databases 29 at step 314 in FIG. 3 and Idle Queue Memory means 516a in FIG. 5 (as described later). In alternate embodiments, the data medication availability data could have been retrieved from other data stores.
Subsequent cells on another spreadsheet (not shown) contain formulas that subtract the total required remaining amount (628) from the total available amount. If the resulting resource availability value is negative, it means there is or will be a shortage of the medication resource.
Programming code in the CEM application 28a then evaluates the resource availability value. If the value is positive and greater than its corresponding stock or buy threshold amount (i.e., a minimum required amount of medication required to be kept in stock), as indicated by rules in the CEM-RD 28b, then the CEM 28a executes the process described below that is triggered when all resources are available. Otherwise, the CEM 28a executes the process described below that is triggered when some resources are unavailable.

Note that a similar resources availability determination process is executed for all categories of resources associated with the target PG or CP Orders.

F. Processes Triggered if All Resources Are Available

Once the target PGs or CPs are selected and, if at step 318 the CEM 28a determines the facility's resources can accommodate the associated PG or CP Orders, then the following processes are executed.

1. Storing Order Information (OI)

In the preferred embodiment, the Order information (OI) of a target PG or CP is sent to a CPOE Database 24b at step 316 by the CEM 28a. The CPOE application 24a may then access the OI from its database 24b at step 316 and display it through the UI of the CPOE application 24a. Note that if there are multiple appropriate PGs or CPs that can be accommodated by available recourses, then the OI of more than one PG or CP may be sent to the CPOE Database 24b. Note that in addition to any PG or CP OI, data from EHR Databases 20b at step 306 may also be accessed by the CPOE application 24a and sent to its database.

In an alternate embodiment of the invention, the OI or EHR data, or both, may be sent directly into memory (RAM) of the CPOE application 24a without being written to the CPOE Database 24b. And in still another alternate embodiment, an appropriate application and database other than a CPOE may be utilized.

2. Modifying Orders

At step 320, any Order's OI may be modified through a CPOE application 24a via user interaction with its UI or through other means. These modifications may be constrained by criteria in the CEM-RB 28b, CPOE application 24a, or other suitable means. In addition, the user may delete (remove) any Orders, as well as add new Orders, unless prohibited by the constraints.

The modified Orders may then be assessed by the CEM 28a to determine if there are adequate resources for their execution, as aforedescribed in step 318. The resource assessment process may be triggered (a) via programming code in the CPOE application 24a that monitors Order modifications; (b) via code in the CEM 28a that, for example, continually monitors the CPOE Database 24b at step 316 for changes to existing Orders; or (c) via other means.

3. Confirming Orders

Having determined that the modified and/or unmodified Orders of one or more target PGs or CPs have adequate resources, the CEM 28a may require confirmation of the Orders by one or more authorized users (e.g., physician in charge) as per step 322. The authorization process may be done through a CPOE application UI 24a via user interaction with its UI and/or via input into other means. While the Orders in the CPOE UI 24a may be represented in text, images, or any other suitable form, in the preferred embodiment of this invention, as aforedescribed, the Orders appear as “objects” that may be mouse-clicked or otherwise manipulated. Confirming an Order may be done, for example, by clicking its object and having its color or other features change to indicate visually that the Order was confirmed by the user.

G. Process Triggered if Some Resources are Unavailable

At step 318, once the most appropriate PGs or CPs are selected by the CEM 28a, the CEM determines if the facility's resources are adequate. If the CEM 28a determines that current resource levels CANNOT accommodate the associated PG or CP Orders, the following processes are executed:
The CEM 28a alerts authorized users of the Orders and resource shortages. The alert message may be sent in a plurality of ways, including having the message displayed via a CPOE UI 24a, via the CEM apparatus UI 10, and/or through another visual means; having the message delivered via an auditory means such as a telephone or computerized sound means; etc. The message may include information such as the patient's name, identification of the specific resource(s) that are deficient, and the amount of and type of resources that are required to execute the PG or CP Orders, etc.
At step 324, a determination is made as to whether adequate resources will be obtained for the deficient resources. In the preferred embodiment, the authorized users are given an option to increase the deficient resources by inputting a response to the alert message via a mouse-click or other action.
If the authorized users respond by indicating a desire to increase the deficient resources, a HIMS application or other means can be used to request an increase of the resource shortage. At step 326, the CEM 28a may automatically trigger the HIMS application or other means through an Application Programming Interface (API) or any other suitable means.
If, however, at step 24b the authorized users respond by indicating that the deficient resources will NOT be increased, then the CEM 28a, at step 328, examines the OI of the deficient resource in accordance with any algorithms in the CEM-RB 28b to determine if one or more alternate Orders can be substituted for the deficient target Order resource (e.g., by substituting a different medication for the deficient one). If the CEM 28a determines that there is at least one suitable Order substitution with adequate resources, via the process aforedescribed in step 310, it then notifies authorized end-users of the suitable Order substitution(s) at step 330. Then, at steps 308 through 322, the Order substitution(s) are modified as necessary and confirmed.
To describe the Order substitution process, return to the aforedescribed Insulin Adjustment PoC example. Suppose the patient suffers a heart attack in the process of executing the PoC. Such an event would force a change in the PoC. For example, the CEM-RB 28b might request changing the target PoC from a time-based sequence of Orders to a time-independent grouping of Orders based on a CP for treating Congestive Heart Failure. In that case, the time-independent Orders might be as follows:
   Observe patient and measure vital signs watching for pulmonary edema or raising pulse, jugular venous distention, or peripheral edema
   Review patient history and previous clinical findings
   Medicate patient to restore stability as required—Administer diuretic and vasodilators
   Monitor hemodynamic parameters
   Perform chest X-ray, pulmonary artery catheterization, electrocardiography or echocardiography as required
   Monitor weight, fluid volume, blood pressure, intake and output, and electrolytes
   Educate patient regarding salt use or medication reaction and follow up
   Discharge—Morbidity potential high; life expectancy 1 to 5 years
In this PoC, events drive Order execution, not time.
Selection of this substitute PoC can be done automatically by the CEM 28a, which retrieves an appropriate PG or CP from the CPG or CCP Databases 26b. This process may be the same as when selecting the original PoC. Alternately, authorized users can manually select the PG or CP. Through the PoC substitution process, the CEM 28a is “unlinking” the original Orders and introducing a new set of Orders.

If there are adequate resources for at least one substitute Order, the CEM 28a may then make the necessary adjustments to the PoC automatically by adding a substitute Order and deleting the deficient Order, or it may request authorized users to make the adjustments manually. If there are multiple possible substitute Orders with adequate resources, and the target Order's OI contains a prioritized list of substitutes, the CEM 28a would choose the Order with the higher priority. If there here are multiple possible substitute Orders with adequate resources, but there is no prioritized list of substitutes, the CEM 28a would display them in a list from which authorized users would select a substitute Order. In the preferred embodiment, the automatic and manual adjustments are done through a CPOE application 24a and the adjustments are stored in a CPOE Database 24b, along with an indication that the adjustments were made due to resource shortages. In an alternate embodiment, a different application and/or data store would be used in lieu of the CPOE.
If there are NOT adequate resources for any substitute Order, or if no substitute Orders are indicated in the target Order's OI, then the CEM 28a notifies the authorized users to obtain an alternative PG or CP, as indicated in the arrow pointing from step 328 to step 302. In the preferred embodiment, the notification would be displayed via a CPOE application 24a, or in an alternate embodiment, a different application and/or data store would be used in lieu of the CPOE. If no suitable PG or CP is obtained, the Order confirmation process is ended and the patient's PoC is no longer managed by the system.

Note that issues concerning resources and actions to deal with resource shortages may be recorded and stored in a suitable data store for later analysis and reporting.

When all Orders comprising a target PG or CP are confirmed, the patient's PoC is complete and the CPOEs UI 24a (or other means) is instructed to display the pending Orders designated for that person. The pending Orders may be displayed one at a time or multiple Orders may be displayed simultaneously. In addition to the Orders, any timeframes within which the Orders must be executed can be displayed. Other information related to the execution of the Orders can also be displayed, such as educational materials associated with the PG or CP.

VII. Ongoing Order Execution Status Alert and Outcome Tracking Processes

Upon the initiation of the PoC execution process, ongoing Order execution status alerts and Order execution outcomes tracking processes begin at step 330, which will now be described with reference to FIGS. 3 through 6.

A. Order Execution Status Alert Process

The Order execution status alert process is an automated process that evaluates Order execution in real time to inform authorized users of orders that are due, late (delayed, but will be done), and dropped (will not done). The process consists of the CEM 28a monitoring Order execution and initiating alerts and automated PoC revisions when problems occur. Thus, when the execution of PoC Orders is not done in a timely manner, the CEM responds to avert possible adverse events.

For example, if a time-dependent Order is executed too late or not at all, it could adversely affect execution of other Orders and result in harm to a patient. For example, in the Insulin Adjustment PoC example, if the patient has severe heart pain at 9:30 AM and the action taken to deal with the heart pain causes a delay in the execution its fourth Order, then the blood would be drawn later than Ordered and the laboratory would likely determine lower glucose levels than if the blood was drawn two hours after eating. Reporting these inaccurate results to a physician would cause him to prescribe the wrong insulin level with potential devastating results. Stopping the Order would reduce the likelihood of a prescription error and adverse event, and would likely reduce the overall cost of care since there would be no charge for the in error laboratory work. This could increase the quality and safety of care delivery. Note that the same alerting process is also triggered for time-independent Orders, except that the timing of their execution is not clock-based, but sequence-based, which means that for an Order to be executed late, a subsequent order (later in the PoC sequence) would have been executed before the late Order.

To avoid an adverse occurrence resulting from Orders executed outside their timeframes or sequences, the CEM 28a alerts authorized end-users when such problem occur, starting in FIG. 3 at step 332, where the CEM continuously evaluates all pending Orders of all PoCs via ongoing processes. Note that a part of this evaluation process involves tracking and evaluating resource availability using a queuing process. This queuing process includes storing, in the CEM's memory, information about Orders that have the necessary resources available and those that do not. This queuing process is described later with reference to FIG. 5. These queues represent dynamic, real-time, short-term memory for the CEM 28a, whereas the data repositories (databases, etc.) represent long-term memory for the CEM.

To obtain the Order execution data to be evaluated, the CEM 28a continuously queries the CPOE Database 24b, or another suitable data store in which the OI of each PoC are stored. The queries may occur according to a pre-established schedule (e.g., every 5 minutes) or by interrupt event. The evaluation process involves having the CEM 28a identify the status of all Orders for all patients being managed by the invention.

The following describes the alerting process.

B. Order Execution Due Alert

In FIG. 3 at steps 336 & 338, if the CEM 28a determines that an Order is currently due to be executed based on the Order's timeframe or the prior execution of Orders upon which it is dependent, then the CEM triggers an alert indication process that by which the Order is indicated to be due for execution. The alert indication process may be done by formatting the object representing the Order in a particular manner via a CPOE 24a or other means, by presenting a message via any means to authorized users, and/or by using any other suitable method of alert.

1. Order Execution Past Due Alert

In FIG. 3 at steps 340, the CEM 28a determines whether an Order that is past due (i.e., late) will be dropped (i.e., it will be executed late) based on authorized end-user input, which is described later.

a. Late Order Will be Executed

If, at step 342, the CEM 28a determines that a late Order will be executed, but requires an adjustment to its timeframe or other modification because, for example, there is a resource shortage or the execution of the late Order will cause problems with other Orders unless it is adjusted, the CEM 28a at step 344, notifies authorized end-users that said PoC must be adjusted. The CEM then executes steps 308 through 322, which enable Orders to be adjusted and confirmed.

Through a process discussed later when describing the order execution status outcome tracking process, the CEM 28a may attempt to automatically adjust the problems by calculating new timeframes for the pending Orders, by obtaining resources to cover shortages, or both, If the CEM cannot establish new Order timeframes necessary for timely execution of the target PoC, or if resource shortages cannot be obtained, the CEM would then instruct the CPOE 24a, or other means, to alert authorized end-users that the PoC Orders must manually readjusted to accommodate the late Order. Note that any OI can be included in the information sent to the end-user by the CEM along with the alert.

If, however, at step 342, the CEM 28a determines that a late Order to be executed does NOT require any adjustment, the CEM, at step 346, notifies authorized end-users that the Order must be adjusted via an alert indication process as aforedescribed.

b. Late Order is Dropped

If, at step 340, the CEM 28a determines that an Order is currently past due and will not be executed, and the CEM determines, at step 348, that the late Order can be dropped without creating problems with other Orders, the CEM notifies authorized end-users that the Order was dropped via an alert indication process as aforedescribed.

If, however, at step 340, the CEM determines that an Order is currently past due and will not be executed, and the CEM determines, at step 348, that dropping the late Order will create problems with other Orders, the CEM notifies authorized end-users, at step 352, that the Order was dropped via an alert indication process as aforedescribed and informs the users that the target PoC must be adjusted to accommodate the dropped Order. The CEM then executes steps 308-322, which enable Orders to be adjusted and confirmed.

C. Order Execution Status Outcome Tracking Process

The Order execution status outcomes tracking process is triggered as an Order's status indication data is input. The input occurs as an end-user indicates that a target Order had been executed or is not going to be executed. The Order execution status outcomes tracking process differs from the aforedescribed Order execution status alert process since the Order execution status alert process is and ongoing automated process that is not triggered by end-user input.

1. Order Status Indicators

Initially, the status of all Orders is indicated to be pending execution. Once the Orders of a PoC begins to be executed, authorized user interacts with a CPOE UI 24a, or the UI of a different application, to indicate whether the status of the Order is:
(a) done early (DE),
(b) done on time (DT),
(c) delayed, i.e., done late (DL), or
(d) dropped, i.e., not done (ND).

The Order status indication can be input using mouse-click objects representing the Orders of a PoC or any other means that enables a user to input the Order indication status, which is stored in a CPOE Database 26b or a different data store. The Order status indication may be displayed in the UI by presenting an object representing the Order in different formats to represent the different Order statuses (e.g., done early is blue, done on time is yellow, etc.).

Inputting an Order indication status triggers the CEM 28a to initiate an evaluation and notification process, which is described below. An Order being evaluated by the CEM will hereinafter be referred to as the “target Order”.

In an alternate embodiment, data about an Order's status may be input automatically into the CPOE Database 26b, CEM 28a or other data store through sensors attached to medical equipment and other devices. There are many ways for the automatic input to be done. For example, a bar code reader could be used to scan whenever a medication Order is executed, and the bar code reader would then send information about the medication for the input. Likewise, an Order for an EKG could be input via a sensor on the EKG machine. An evaluation and notification process similar to the aforedescribed is triggered upon automatic input of the Order status data.

2. Orders at Variance

When an Order was done early, delayed, or dropped, it is considered to be at “variance”. There will reasons (causes) for the variant Order, such as:
PATIENT s cause of variance (e.g., patient death, patient transfer to another facility, patient refusal, abnormal test results, etc.)
PROVIDER as cause of variance (e.g., team responded late, lack of team consensus, alternate physician order, etc.)
INTERNAL SYSTEM as cause of variance (e.g., medications not available, equipment not available, staffing not available, etc.)
EXTERNAL SYSTEM as cause of variance (e.g., transportation not available, safe environment not available, regulatory/legal issues, etc.).

One or more Order variance reasons may be indicated by an authorized user by mouse-clicking one or more objects representing the specific variance reasons, or any other means may be used that enables a user to input the variance reasons. The variance reasons may be input through a CPOE UI 24a, or the UI of a different application may be used.

Note that when a variance reason is input for a dropped target Order, the CEM 28a may be triggered to request the input a description of any alternate Orders that have replaced the target Order. The alternate Orders may be input through a CPOE UI 24a, or the UI of a different application may be used.

Following describes the Order execution tracking, notification and adjustment process.

3. Order Execution Tracking, Notification and Adjustment The Order execution tracking and notification process begins at decision step 402 in FIG. 4. The CEM 28a utilizes a queuing process, represented in FIG. 5, to track Orders. As will be discussed later:
the Resources-Needed Queue contains data about Orders that have been issued, authorized and are awaiting processing;
the In-Process Queue contains data about Orders that have been issued and authorized, and the resources needed for their execution have been allocated;
the Idle Queue contains data about Orders in which there is a resource availably or other problem, so they are on hold until the problem is resolved or the Orders are dropped;
the Active Queue contains data about Orders having adequate resources and are in the process of being executed; and
the Completed Queue contains data about Orders that have been already executed or dropped.

The CEM 28a then performs the following processes.

a. Target Order was Not Dropped (Done On Time, Early or Delayed)
If the target Order, at decision step 404, was not dropped, then the CEM 28a identifies the Order status as executed on time (DT) at step 406.
If the target Order, at decision step 404, was NOT executed within its scheduled timeframe, and instead, as noted at decision step 408, the Order was executed late (DL), and if the late execution of the Order does not cause problems with the execution of pending Orders as per decision step 410, then the CEM 28a identifies the target Order status as executed late (DL) and requests the aforedescribed reasons for variance at step 412.
If the target Order, at decision step 404, was NOT executed within its scheduled timeframe, and instead, as noted at decision step 408, the Order was executed late (DL), and if the late execution of the Order DOES cause problems with the execution of pending Orders as per decision step 410, then the CEM 28a the following at step 414:
   Instructs CPOE (or other application) to indicate that the late execution of the target Order is causing execution problems with the pending Orders, which requires that the PoC must be manually adjusted;
   Indicates that the target Order status was executed late (DL) and
   Requests the reasons for the variance.
If the target Order, at decision step 404, was NOT executed within its scheduled timeframe, and instead, as noted at decision step 408, the Order was executed early (DE), and if the early execution of the Order does not cause problems with the execution of pending Orders as per decision step 410, then the CEM 28a identifies the target Order status as executed early and requests the aforedescribed reasons for variance at step 418.
If the target Order, at decision step 404, was NOT executed within its scheduled timeframe, and instead, as noted at decision step 408, the Order was executed early (DE), and if the early execution of the Order DOES cause problems with the execution of pending Orders as per decision step 410, then the CEM 28a does the following at step 420:
   Instructs CPOE (or other application) to indicate that the late execution of the target Order is causing execution problems with the pending Orders, which requires that the PoC must be manually adjusted;
   Indicates that the target Order status is executed early; and
   Requests the reasons for the variance.

b. Target Order Was Dropped
(a) If the target Order, at decision step 404, was dropped, and the CEM 28a determines that pending Orders can be executed satisfactorily despite the dropped target Order, as per step 422, then the CEM identifies the target Order status as dropped (ND) and requests the aforedescribed reasons for variance at step 424.
(b) If the target Order, at decision step 404, was dropped, and the CEM 28a determines that pending Orders can NOT be executed satisfactorily due to the dropped target Order, as per step 422, and the CEM is able to re-calculate satisfactory timeframes for all pending PoC Orders at step 426, then the CEM does the following at steps 428 and 432:
   Calculates new timeframes for the pending Orders;
   Sends the new timeframes to a CPOE Database 24b, or to another suitable data store;
   Indicates the target Order status as dropped (ND);
   Requests input of the reasons for variance; and
   Requests input of any substitute Orders.
(c) If the target Order, at decision step 404, was dropped, and the CEM 28a determines that pending Orders can NOT be executed satisfactorily due to the dropped target Order, as per step 422, and the CEM is NOT able to re-calculate satisfactory timeframes for all pending PoC Orders at step 426, then the CEM does the following at steps 430 and 432:
   Instructs CPOE UI 24a (or to another suitable UI) to indicate that the PoC Orders must be manually adjusted to accommodate the dropped Order;
   Indicates the target Order status as dropped (ND); and
   Requests input of the reasons for variance.

D. Ongoing Queuing Processes

Queuing is utilized for ongoing (periodic and continuous) monitoring of resource availability and Order execution for all PoCs, beginning with the assessment of resource availability when establishing a PoC at step 310 and when executing Orders at step 332 (both in FIG. 3). The ongoing queuing process will now be described with reference to FIG. 5.

The purpose of queuing is to avoid adverse events (e.g., patient injury or death due to errors, omissions, etc.) by tracking the delivery of PoC Orders and the availability of resources required to execute the Orders. The queuing method utilizes a process known as “look ahead” whereby the timing for execution of each PoC's Orders and the resources needed for proper execution of those Orders are tracked by queues that are built by the CEM 28a as each PoC is confirmed.

In the preferred embodiment of the invention, the CEM 28a builds the queues by using any suitable programming code to:
(a) Obtain information from the CPG or CCP Databases 26b about each resource required by each of the PoC's Orders as indicated by each Order's OI and
(b) Transmit resources-required and resources-available indications to the queue(s)' memory means in any suitable data formats.

The data about each resource an Order requires may include indications of the type of resource needed, the amount needed, when it will be needed, how long it is needed, the location of the resource, its priority status, and/or other relevant data. Any suitable computer processes and code may be used to query the CPG or CCP Databases 26b to obtain the OI requirements and write it to the Queue's storage means and/or memory.

The information retrieved from the facility's Resources Databases 29 may include data such as:
the type of resource needed (e.g., the resource ID number);
whether the resource is currently idle and available;
if it is available, how much is available;
what alternate resources can be used;
if it isn't available, when it is expected to be available;
where the resources is located; the cost of the resource; and/or
any other information about the resource and its availability.

As an Order is executed, the CEM 28a updates the corresponding queues to indicate any changes in resource requirements. A resource can be indicated to be in one of the following states:
current available (ready to be deployed or be used);
needed, requested, and in process of being made available;
needed, requested, but not yet in the process of being made available;
needed, but not requested.

To assess resource availability at any instant, the CEM 28a accesses the Resources Databases 29 and stores this information in dynamic queues in its memory.

In the preferred embodiment of the invention, five queues are implemented:
Resources-Needed Queue (RNQ) 504,
In-Process Queue (IPQ) 506,
Active Queue (AQ) 512,
Completed Queue (CQ) 514, and
Idle Queue (IQ) 516.

Each queue is controlled by the CEM 28a. Note that a single queue may contain the resources-needed and resources-available data indications that are associated with a single PoC, or it may contain those data for a plurality of PoCs.

The following example illustrates how each of the queues facilitates the resource management process.

1. Serving the Resources Needed Queue (RNQ)

The resource in the example is a bed on a specific floor in a specific heart trauma unit in a specific hospital. A patient was pre-admitted to the hospital for heart bypass surgery and will need the bed at a predetermined future date. During the preadmission process, at step 502, the PoC is selected by an authorized user via a CPOE application 24a or via another suitable means, and the associated PoC Orders' OI is stored in the CPOE Database 24b or another suitable storage means. At a point in time defined by instructions in the Orders' OI, the CEM-RB 28b, or both, the CEM 24a serves (i.e., sends) the resources-needed data from specified Orders' OI to the memory means of the RNQ 504a, which may be storing resource-needed data for a plurality of pre-admitted and admitted patients. The point in time for serving the specified resources-needed data may be based, for example, on a certain number of days prior to the date a pre-admitted is scheduled to be admitted, in order to give personnel enough time to make the requisite bed available when the patient is actually admitted.

Note that a similar process occurs when a patient is admitted without first being pre-admitted, such as an emergency room admission. In such a case, the resources-needed data is served into the memory means of the RNQ 504a upon admission.

2. Serving the In-Process Queue (IPQ)

The RNQ 504b processing means then serves specific resources-needed data to the IPQ memory means 506a at a point in time defined by the queue's buffer behavior to indicate that the resources are needed immediately or relatively soon. For example, availability of the requisite bed may be given a high priority behavior (i.e., a Priority Queue type as aforedescribed) since an appropriate bed is likely to be one of the first resources that must be made available for a newly admitted patient. In addition to the bed resource, other required resources in the RNQ 504a, such as operating room, technicians, tools, staff, etc., are served by the RNQ 504b processing means to the IPQ memory means 506a as specified by the queue's buffer behavior. The IPQ processing means 506b then serves the appropriate resource-needed data to the CEM 28a, at step 510, at which time the CEM determines if the needed resource are, in fact, currently available.

3. Determining Resource Availability

Upon receipt of the resource-needed data from the IPQ processing means 506b, the CEM 28a determines the availability of resources by comparing the resource-needed data with the actual availability of the resources as indicated by the data CEM 28a queries from the associated facility's Resources Databases 29 and from the Order indication data in the for Orders in an Inactive state in the IQ 516 (described later).

The CEM 28a may be able to determine resource availability reliably from a short period of time (e.g., the availability to resources to execute a single Order) to a long period of time (e.g., the availability of resources to execute a plurality of Orders across a plurality of days of care). These time periods depend on (a) the frequency the Resource Databases 29 are updated, (b) the frequency at which the availability of the requisite resources change, and (c) the sparseness of required resources.

Different methods may be used to determine if a particular resource in a particular Resources Database 29 is available. For example, the determination that a suitable bed is available may require that engineering, housekeeping, the floor nurse and/or other staff input data into the Space Database 29b that indicate a suitable bed is available. Determining that a medication is available, on the other hand, may only require that the Inventory Database 29a be updated appropriately.

Following is a description of processes through which the CEM 28a determines resource availability. These processes may be launched when the Resources Databases 29, PoC, or CEM-RB 28b change, as well as repeating on a time-based cycle or other method of repetition. If shortages are calculated, the CEM 28a executes warning and/or alerts.

a. Calculating Inventory Availability

The CEM 28a calculates inventory availability by totaling the amount of supplies to be used for each PoC Order in the RNQ for a patient's estimated length of stay (i.e., the duration of the PoC). The CEM may also use certain criteria in its Rules Base 28b when estimating depletion of a category of supplies, e.g., by establishing stock threshold levels below which supplies are to be ordered for restocking. Note that there may also be an upper inventory threshold, which is the sum of the resources needed for current plus projected Orders, plus a possible additional surplus (reserve) amount; no restocking orders would be allowed above that number.

The previous Microsoft Excel spreadsheet example described how a spreadsheet can be used to evaluate resource needs and availability. An example will now be described that shows how the CEM 28a, at step 510, determines whether there are enough special bandages to complete the current Orders, or whether additional bandages should be ordered. This determination can be based on the aggregate data (i.e., are there enough bandages for all PoCs) and/or on individual PoC data (are there enough bandages for a particular PoC). It can also be determined for different time periods (e.g., are there enough bandages for all PoCs for their entire estimated length of stays or are there enough for a single day the next hour, the next Order, etc.). Spreadsheets and/or other means may be utilized to perform the following computations, as well as computation for the availability of other resource for other Orders.

In this bandages example, assume information about 5 patients' PoC Orders in the RNQs 504a indicates a requirement for an average of 10 special bandages per day for each patient (i.e., 50/day). Also assume that each of those patients has the Order in their PoC for the current day and for the next 3 days (i.e., 50×4=200). The CEM 28a then calculates the need for a minimum of 200 bandages, to have enough inventory for three consecutive days. Further assume that the CEM's Rules Base 28b indicates that the inventory for those bandages should never drop below a 100 unit reserve (“cushion”) threshold level (because, for example, they are used in emergencies and could take several days to re-supply). The CEM then calculates that at least 300 (200 estimated total plus 100 cushion) of those bandages are needed to meet the aggregate requirements for the next three days at a usage rate of 50/day. These aggregated, projected data are then served to the IPQ memory means 506a. Instead of these aggregated data, or in addition to them, the CEM may store in the IPQ memory means the bandage resource needs for each PoC individually.

To make these determinations about resource availability, the CEM 28a compares the required number of bandages (in aggregate or for individual PoCs for the entire estimated length of stays or for a specific time periods) with the total bandages stored in inventory based on querying the inventory tables in the facility's Resources Databases 29a. This involves having the CEM make a series of calculations using any suitable processes and code. Depending on the time period and amount of aggregation, 10 bandage units are subtracted from the total number of currently available bandage units for a specific number of days and PoCs.

A similar process occurs for medical equipment inventory, but instead of calculating the number of units required and available, the CEM 28a calculates duration of time the equipment is being used, in repair, or otherwise unavailable for a particular Order or aggregate number of Orders. This equipment would be placed in the idle queue and marked unavailable. For example, there may be a particular medical device patients' A and B need to execute Orders defined in their RNQs, but the facility has only one of them. If the patients need to use it for, say, 2 hours each, and patient A is scheduled to use it at 9 AM and patient B at 10 AM, there is a conflict and the appropriate staff is alerted as described above. Even if there is no immediate time conflict, the CEM-RB 28b may have criteria indicating time to deliver and set-up the equipment, which the CEM would take into account in its calculations.

b. Calculating Space Availability

The CEM 28a calculates space (rooms) availability by totaling the number of rooms by room-type to be used for each PoC Order in the RNQs for each patient's estimated length of stay. The CEM may also use criteria in its Rules Base 28b when estimating space availability, including room location or type.

For example, depending on the patient's condition and PoC, the patient may require a bed on a particular floor in a particular hospital unit before the PoC can be executed. And once care begins, the patient may have to be moved to different rooms (temporarily or permanently) as other Orders are executed. Room availability is determined by accessing the storage means that track room usage, which may be the Space Database 29b or space tables in a combined Resources Database 29.

c. Calculating Staff Availability

Facilities may pool staff into teams based on required groupings of their roles, responsibilities, and competencies. There may also be staff in reserve capacity should shortages of primary staff occur.

In addition to the inventory and space requirements in the RNQs, all patients' PoCs have required staff types (e.g., resident physician, cardiac surgeon, RN, LPN, therapist, technician, orderly, etc.) associated with them, and with each Order to be executed. The Staff Database 29c or staff tables in a combined Resources Database 29 contains information about each staff person, which may include the person's roles, responsibilities, competencies, schedules of availability, locations, and/or other information. The CEM 28a may also use certain criteria in its Rules Base 28b when estimating staff availability, including allowable staff substitutions, what to do when a staff shortage occurs, etc.

The CEM 28a examines its RNQs to determine what staff persons are required to execute the PoC and each of its Orders. The CEM determines staff availability by querying the Staff Database 29c or staff tables in a combined Resources Database 29 and comparing the staff required to the staff available data.

d. Resource Availability Determination Constraints

The CEM-RB 28b may include constraints on the timeframe within which the resource availability determinations are made. The timeframe may be short (e.g., one hour or one day) or long (e.g., entire patient length of stay). And the constraints may vary by the type of patient condition, PoC and/or Order. These constraints may, for example, instruct the CEM 28a not to determine resource availability for particular Orders that are at least an hour late for execution. Note that there may also be constraints on the upper level of resources (i.e., a threshold above which resource levels must not be increased), as well as the lower level (i.e., a threshold below which resource levels must be increased). In addition to time constraints, it may be possible to establish resource determination constraints based on Order sequences, external events, etc.

Once an Order's resource availability is determined at step 510, different processes are triggered by the CEM 28a depending on whether the required resources are available or unavailable.

4. If All Resources are Available

If the CEM 28a determines that that all the resources to execute an Order are available, it sends data to the AQ memory means 512a indicating the resources are available, which means the Order is ready to be executed when due.

a. Active Queue (AQ) and Completed Queue (CQ) Processing

Upon execution of an Order, the AQ's Processing means 512b serves data indicating the Order was executed to the CQ Memory means 514a. While it may be possible for the invention to operate without a CQ, it is beneficial to utilize one because it provides a more rapid means by which to determine when all the Orders in a PoC have been completed through Order execution, dropping (skipping) Orders, patient death, transfer from the facility, and any other possible way to complete (or terminate) a PoC.

Order completed indication data remain in the CQ Memory means 514a until the CEM 28a determines all the Orders in the associated PoC are completed. This determination may be done by having the CEM 28a (a) compare the Order completed indication data with a list of all the Orders in the PoC or (b) receive notification, through database queries or other methods, that a patient has died, has been transferred to another facility, or has otherwise terminated care

The CEM 28a may sample (access) the CQ Memory means 514a (a) as the completed indication data for each Order are served to the CQ Memory means 514a; (b) on a predetermined time cycle (e.g., every 2 minutes); or (c) via other triggers.

b. Serving the Idle Queue (IQ)

As described below, the Order completed indication data are then served to the IQ Memory means 516a with additional data indicating an Order's state. The state of an Order may be either:
(a) Active state, which means the Order has not yet been executed due to insufficient resources or another problem with it execution, so it's resources are not available because they will be used; or
(b) Inactive state, which means the Order has already been executed or will not be executed, thus its resources are now available for use by other Orders.

As aforedescribed, the CEM 28a samples the CQ Memory means 514a for Order completed indication data. Since all completed data are in an Inactive state, the CEM 28a then instructs the CQ Processing means 514b to serve the sampled Order completed indication data to the IQ Memory means 516a with additional data indicating the Order is in an Inactive state.

In either case, the benefit of using the IQ is that, being a memory-based storage means, the data it stores may be more up-to-date than the corresponding Resource Database 29, which typically takes more time to be updated.

c. Completed PoC Processing

If the CEM 28a determines all Orders for a PoC have been complete, it may notify a HIMS application 22a or other application(s), using any suitable programming code, that the patient associated with the PoC has completed his/her length of stay. The CEM 28a instructs the CQ Memory means 514a to remove all Order completion indication data associated with the completed PoC, and it may send alerts of authorized personnel notifying them that the patient's length of stay has ended.

5. If Some Resources are Unavailable

If the CEM 28a determines that that any resources an Order needs is not available, it performs the following processes, which begin at a patient's pre-admission (or admission) and run continuously until the patient is discharged, transfers to another facility, dies, or if care is terminated for other reasons.

a. Serving the Idle Queue (IQ)

When the CEM 28a determines that that any resources an Order requires is not currently available or will not be available when needed, it instructs the IPQ Processing means 506b at step 510 to serve to the IQ Memory means 516a the Order's data indicating the unavailability of the required resource(s). As aforedescribed, an Order's state may be Active or Inactive. When there is a lack of resources, an Order in the IQ is indicated to be in an Active state, which means it has not yet been executed because the required resources are not yet available.

The CEM 28a may also send alerts to authorized users about the resource shortage, as well as trigger processes for managing the resources, as discussed below.

b. Sending Alerts about Unavailable Resources and Managing Shortages

Alerts are sent by the CEM 28a whenever it determines a required resource for an Order is unavailable. The nature of the alerts depends on the type of resource that is unavailable. Following are examples.

i. Inventory

As aforedescribed, if 300 bandages are needed, but only 100 are currently available, there would be a shortage of 200 bandages. As soon as the CEM 28a determines the shortage exists, it may send alerts to the appropriate users as defined in the CEM-RB 28b, the Staff Database 29c, and/or another location. These alerts inform the individuals that there is (or will be) an inventory shortage of the bandages, and specifies the particular Order. If resource shortages are projected at a future point in time, the CEM 28a would indicate when the shortage is likely to occur. The alerts may also include the estimate of the actual number of bandages available for use, if any, as well as the rules base criteria of a cushion amount. This same process is repeated for medications and other inventoried materials.

Note that it may also be possible for the CEM 28a to interoperate with a HIMS application 22a to place orders for inventory shortages through restocking.

ii. Space

Whenever a room is determined not to be available when needed, the appropriate users are alerted as aforedescribed. The alert may include information about alternative rooms to use based on CEM-RB 28b criteria, why the room is not available, estimate of when the room will be available, etc.

Note that it may also be possible for the CEM 28a to interoperate with other systems for managing space to facilitate the allocation of beds when shortages occur or are projected.

iii. Staff

Whenever a required staff person is determined not to be available when needed, the appropriate user(s) is alerted as described above. The alert may include information about what type of staff person is needed, what staff are available (if any), what Order they have to execute for the patient, when and where the Order is to be executed, etc.

In case of an emergency situation, staff in a reserve pool, identified as idle queue inactive, may be alerted, the number needed, determined by accessing the appropriate tables in the facility's Resources Database, if any such pool of reserve staff exists. Note that the reserve pool may also be accessed and alerted if the CEM 28a calculates that there will be a staff shortage to execute existing Orders indicated in the RNQ(s) at some future point in time. This calculation may include a probability function of staff availability as per the CEM-RB 28b.

Note that it may also be possible for the CEM 28a to interoperate with other systems for managing personnel (e.g., software systems for nurse staffing, personnel scheduling, etc.) to facilitate the allocation of staff when shortages occur or are projected.

c. Managing Active State Orders in the IQ

Indication data for Orders in which requisite resources are lacking remain in the IQ Memory means 516a in an Active state until the CEM 28a determines that the resource shortages are rectified or the Order is dropped. This determination may be done by triggering the CEM 28a to query the associated Resource Databases 29 whenever there is an update to the databases, and then evaluating the current resource levels against the required levels based on data in the RNQ Memory means 504a.

i. When Resources Shortages are Rectified Before an Order is Due for Execution

When the CEM 28a determines that an Order in Active state in the IQ Memory means 516a no longer has resource shortage(s), it instructs the IQ Processing means 516b to serve the Order's indication data to the RNQ 504a Memory means, at which point it re-enters the aforedescribed queuing process. The CEM 28a may alert authorized users with a message indicating that the resources are now available.

ii. When an Order is Late for Execution Due to Resources Shortages

It is possible that resources shortages are rectified after an Order is due for execution, or that the resource shortages are never rectified. In either case, the Order cannot be executed on time. If the lacking resources become available after the Order is past due, the CEM 28a may alert authorized users with a message indicating the resources are now available, but the Order is late for execution; and the process continues as aforedescribed for late Orders. If the lacking resources are made available after the Order has been dropped, the CEM 28a may alert authorized users with a message indicating the resources are now available even though the Order has been dropped; and the process continues as aforedescribed for dropped Orders.

6. Using Queues when Establishing PoCs

As aforedescribed, the queuing process may be part of the PoC establishment process. Returning to FIG. 3, at step 310 the CEM 28a queries the Resources Databases 29 to determine resource availability. This may cause a problem the databases have not yet been updated to reflect recent changes. Returning back to FIG. 5, the IQ Memory means 516a, however, stores Order indication data in real time, which may provide current information about resource availability before the Resources Databases 29 are updated. The CEM 28a may, therefore, sample the IQ Memory means 516a to obtain data about the resource shortages of Active Orders and the resource availability of Inactive Orders. By comparing date stamps depicting when the corresponding resource data were updated in the Resources Databases 29 and were recorded in the IQ Memory means 516a, the CEM 28a can compute resource availability in an accurate and timely manner when establishing PoCs.

7. Using Queues to Assist with Order Execution Tracking

Returning to FIG. 3, at step 332 in the preferred embodiment of the invention, the CEM 28a may sample the AQ Memory means 512a (FIG. 5) to confirm that Orders not yet executed have the resources they require. This memory access process may be triggered according to instructions in the CEM-RB 28b. For example, the CEM 28a may be instructed to sample the AQ 512a Memory means at a predetermined time period, including prior to the timeframe the Order execution is due, when the Order is due to be executed, and during late execution of the Order. Or the instructions may be based on an Order sequence criteria (e.g., next Order due for execution), as well as any other suitable instructions.

In an alternate embodiment, instead of utilizing queues, the CEM 28a may repeatedly access databases or other storage means that store data indicating Orders having adequate resources for execution. This database “polling” process may be less desirable than the queuing process, however, because it requires additional computer processing resources and memory bandwidth, as well as causing response time delays.

E. Victims Routing Rules

During a disaster, pandemic or terrorist attack, the CEM 28a obtains information about available resources from a plurality of hospitals and ancillary care facilities in order to determine where victims can be sent for triage and trauma center care. Any suitable methods for obtaining this information can be used, such as remotely querying the Resources Databases from the facilities and pooling the data. In addition, data about the best roads for emergency personnel to travel to get to the facilities can be obtained via any suitable method, including accessing real-time satellite views of roadways and data from transportation departments.

The CEM 28a then uses information about available resources at the facilities to match the needs of victims to the available resources at the facilities. This process is similar to the aforedescribed processes for estimating resource availability, except that the PoCs authorized by the emergency medical technicians and other emergency personnel are more likely to be initial triage estimate instead of complete plans of care. As such, the Orders will be more limited in scope and detail, such as treat victim for 3^{rd} degree burns, which the CEM would use to find the nearest facility able to treat burn victims and then alert emergency personnel to transport the victim to that facility.

F. Patient Priorities Rules

When certain resources are not adequate to enable the timely execution of all PoCs in the RNQs, the CEM-RB 28b may use rules to give the limited resources to more seriously ill patients, so they are treated sooner and with fewer potential interruptions in care. The CEM 28a can use any suitable programming code and processes to prioritize the resource needs of these higher priority patients and to alert authorize users that the resources for lower priority patients are unavailable. This means the CEM 28a may re-sort the order of Orders in the queues by the priority rules, which might also change the Order status indicator. For example, an Order that has a higher priority status indicators in its OI than other Orders in a queue, is arranged in the queue to be processed before lower priority Orders.

VIII. Entering Outcomes Data

Data about clinical and financial outcomes may be collected, in addition to data about PoC Orders (OI), Order status, variance, and resources. The outcomes data may be collected using the UI of an EHR 20a, CPOE 24a, CEM 28a, or another software application and stored in a corresponding data store.

IX. Generating Reports

A plurality of informational reports in a many different formats, and containing a wide variety of content, may be generated by a CPOE 24a, CEM 28a, or another software application using any suitable programming code. Following are examples of the reports.

A. PoC Order Execution Status Reports

In addition to viewing a patient's PoC Orders on screen as aforedescribed, the status of a single patient's Orders, or the Orders of multiple patients, spanning any period of time, can be generated for viewing on screen and/or in print. The parameters for the reports, in terms of time periods and Order attributes (e.g., execution status, staff executing the Orders, etc.), are entered by authorized users into the UI of the report generation application.

B. Resource Use and Availability Reports

Reports may be generated that comprise any or all the information about resource use and availability contained in the queues, Resources Databases 29, CEM-RB 28b, and other storage means,

C. Variance and Outcomes Reports

Analytic reports evaluating Order execution variances, as well as and clinical and financial outcomes, may be generated. The reports may help develop clinical knowledge and improve care quality by, for example, providing information aggregated across patients about:
(a) patients' clinical condition at admission and discharge, length of stay, expenditures;
(b) why Order variances occur;
(c) how Order variances relate to outcome measures. That is, how deviations from a PoC affect patients' health, functionality, length of stay, expenditures, everything etc.; and
(d) the nature of variance, including whether each variant process was delayed, early, or dropped, or if new processes were added to the pathway at time of care.

With this information, additional knowledge is gained. For example, if executing all the Orders as recommended in a particular PoC is correlated with positive outcomes for particular types of patients, the PoC receives validation support for it being useful with the patient types. If, however, complying with particular PoC Orders do not correlate with good outcomes, knowledge may be gained about how the PoC may best be modified by changing certain of its Orders (e.g., it may show that when medication X is administered to patients with diagnosis Y earlier in the pathway than originally recommended, the outcomes are significantly better). This information also identifies why particular PoCs are not followed precisely, so that action can be taken to enhance compliance to PoC that bring about positive outcomes.

### Summary, Ramifications, and Scope

Accordingly, the invention provides a method and apparatus that streamlines healthcare planning, delivery and continuous quality improvement by combining the functionalities of multiple health information technologies-together with other functionalities—in a single integrated software system.

The apparatus of the invention is comprised of a digital computer system comprising a Central Processing Unit (CPU), Read Only Memory (ROM) device, Random Access Memory (RAM) device, input device, storage device, presentation device, backup system, and user interface and delivery device. These components enable the computer system to compile, process, transmit, and report information and/or data from one or a plurality of end users in one or more users and/or locations.

The method of the invention comprises processes that assist healthcare workers in managing each patient's plan of care (PoC) by the following nine processes:
establishing patients' PoCs;
evaluating required against available resources;
instructing authorized users of the appropriate healthcare facilities where there are sufficient resources to execute PoC Orders;
notifying authorized users when resource shortages currently exist or are projected within a facility;
enabling resources to be increased or PoCs to be adjusted in order to account for resource shortages;
tracking the execution status of PoC Orders;
notifying authorized users of the status of PoC Orders, including when particular Orders are due for execution or are late;
alerting authorized users when early or late Order execution, or dropping (not executing) an Order, is likely to cause problems in the care of a one or a plurality of patients;
assisting authorized users in adjusting any Orders parameters (attributes) that might cause a problem if executed, so as to prevent problems from occurring; and
generating reports showing healthcare delivery performance and giving insight into ways to improve the performance.

Although the descriptions above contain many specificities, these should not be considered as limiting the scope of the invention but as merely providing illustrations of some of the presently preferred and various alternative embodiments of the invention. Accordingly, the invention includes all modifications and/or variations of the embodiments described herein with the scope of the invention limited only by the claims which follow.

What is claimed is:

1. An apparatus for inputting, obtaining, storing, analyzing, transmitting, and reporting data, as well as for utilizing a rules base to evaluate said data and to trigger a plurality of processes comprising the functionalities of a plurality of software technologies, with said apparatus being comprised of:
(a) an electronic execution means providing control over said apparatus via instructions from at least one algorithm, stored in at least one file, comprised of at least one of computer programming code, macros, functions, and formulas;
(b) a user input means for entering commands providing further control over said apparatus, and for entering said data and algorithms into said apparatus;
(c) a memory means for maintaining said data in electronic and/or magnetic form;
(d) a data compilation means for acquiring and storing said data;
(e) a storage means for storing at least one of said data and algorithms;
(f) at least one rules base comprising at least one computer-based algorithm;
(g) a presentation means for providing an indication of said operation of said apparatus and for displaying said reports; and
(h) an output means for outputting said reports;
whereby the functionality of a plurality of independent information technologies are integrated into a single coordinated system that manages, tracks, adjusts, and reports the execution of specified healthcare orders comprising one or more plans of care and the availability of resources required to execute said orders.

2. The apparatus of claim 1 wherein said rules base may be comprised of one or more programming code modules, databases, spreadsheets, flat files and/or other electronic means within which resides at least one computer-based algorithm consisting of a finite set of well-defined instructions implemented by said apparatus as mathematical functions, procedural methods, or both. Said apparatus utilizes said algorithms when processing data obtained from one or more databases or other data stores.

3. A method utilizing processes for inputting, obtaining, storing, analyzing, transmitting, and reporting data, as well as for utilizing a rules base to evaluate said data and to trigger a plurality of processes comprising the steps of utilizing at least one algorithm comprised of at least one of computer programming code, macros, functions, and formulas for:
(a) manually inputting data;
(b) obtaining data from one or a plurality of data stores, other electronic means, or both, including, but not limited to, databases, flat files, spreadsheets, and electronic sensors;
(c) storing said data in RAM memory, ROM-based data stores, or both;
(d) processing said data to establish a plurality of orders comprised of tasks that may indicate where, when and how care should be delivered;
(e) processing said data to determine the availability of resources relative to need;
(f) providing instructions indicating where, when and how said orders should be executed;
(g) providing alerts and/or warnings;
(h) providing an electronic means to adjust resources as required to execute said orders properly;
(i) processing said data to determine and track the status of said orders;
(j) providing alerts and/or warnings when said orders are due to be executed or are past due;
(k) inputting data about the reasons said orders were not executed as indicated;
(l) adjusting said orders through a manual user interface means, an automated electronic means, or both;
(m) adjusting said resources;
(n) collecting, storing, and analyzing data; and
(o) generating reports;
whereby said processes provides an efficient and unified computerized means for establishing, tracking, managing, analyzing, and reporting on the execution of a plurality of said orders.

4. The method of claim 3 wherein at least one healthcare plan-of-care comprising a predefined, modifiable order or set of orders is established from practice guidelines, clinical pathways or other means that define recommended processes and resources for the execution of said orders;
whereby the process of establishing plans of care is facilitated.

5. The method of claim 3 wherein data defining parameters of acceptable execution of said plan-of-care orders are utilized to determine if said orders are executed within the defined timeframes or sequences;
whereby data is available for use by processes that provide information about the status of the execution of said orders.

6. The method of claim 3 wherein data may be input via manual data entry means, through automated sensors or via other means, and wherein data may be stored in and accessed from a plurality of data stores.

7. The method of claim 3 wherein a plurality of information systems and other technologies may be utilized in conjunction with an electronic care execution management means;
whereby the capabilities of a plurality of information systems and other technologies provide additional functionalities that augment the functionalities of the method of claim 3, such as facilitating the establishment and effective delivery of plans of care; enabling first responders and trauma unit staff to communicate, access information, and make decisions in emergency situations; providing tools for analyzing care outcomes; and performing processes involving the interoperability of information systems and other technologies.

8. The method of claim 3 wherein an electronic queuing means may be utilized to:
(a) determine the availability of current and projected resources that are required for establishing and/or executing said orders and/or
(b) help manage the execution of orders;
whereby an efficient means may be utilized for obtaining timely information about required resources and the timing or sequence of order delivery.

9. The method of claim 3 wherein instructions are provided that indicate information about facilities having adequate resources to execute said orders, when there are a plurality of possible facilities from which to chose;
whereby patients may be routed to the facilities that are best able to deliver the care they require.

10. The method of claim 3 wherein priorities are established by which criteria are used to execute higher priority plans of care before lower priority plans of care;
whereby priority is given to the allocation of resources to patients requiring more immediate attention.

11. The method of claim 3 wherein a determination of inadequate resource availability within a healthcare facility triggers the delivery of alerts, warnings, or both;
whereby individuals in said facility are made aware of resource inadequacies and are given an opportunity to adjust said inadequacies so as to avoid problems with care delivery.

12. The method of claim 3 wherein a determination of said inadequate resource availability triggers manual processes, automated processes, or both, which enable adjustment to said resources to adequate levels, adjustment of orders to accommodate resource shortages, or both.

13. The method of claim 3 wherein the execution of said orders may be based on:
(a) time, such that the proper execution of said order is defined to be within a particular timeframe;
(b) sequential dependences, such as when the execution of certain orders depends on the execution of other orders; and/or
(c) priority criteria;
whereby the method best suited for determining when a order is to be executed may be utilized.

14. The method of claim 3 wherein the delivery of alerts, warnings, or both is triggered when an order is due to be executed or is past due;
whereby personnel are informed about the status of said orders, so they may respond in a timely manner.

15. The method of claim 3 wherein the delivery of alerts, warnings, or both is triggered when the early execution, late execution, or non-execution any of an order is determined to be a likely cause of problems in the execution of care for at least one patient;
whereby personnel are informed about current and potential problems with the execution of said orders, so they may resolve said problems.

16. The method of claim 3 wherein the delivery of alerts, warnings, or both is triggered when other problems occur or may occur with any patients, with a healthcare facility, and/or with other factors that are unrelated to said early, late, or non-execution of orders;
whereby personnel are informed about current and potential problems with the execution of said orders, so they may resolve said problems.

17. The method of claim 3 wherein data are collected about the reasons said orders were not executed as indicated, which may include patient factors, healthcare provider factors, internal faculty factors, external factors, etc.;
whereby personnel are informed about current and potential problems with the execution of said orders, so they may resolve said problems.

18. The method of claim 3 wherein data related to the results said order execution may be collected, stored, and analyzed, which may include data about patients' clinical condition at admission and discharge, length of stay, expenditures, etc.;
whereby information is collected that may be valuable to understanding the care delivery process and how it may be improved.

19. The method of claim 3 wherein output reports are generated that provide information selected from the group of reasons for not executing orders as indicated in the plan of care, the effect of executing said orders as indicated, the effect of not executing said orders as indicated, the effect of executing alternate orders, issues concerning resources, and actions to deal with resource shortages;
whereby informational reports are generated that may be valuable to understanding the care delivery process and how it may be improved.

20. The method of claim 3, further including models, processes and measures applicable to non-healthcare industries that may be substituted for the healthcare models, processes and measures, including:
(a) substituting plans of care, orders, practice guidelines, and clinical pathways with strategies and tactics, plans and operations, regulations and procedures, policies and methods, etc.;
(b) substituting instructions identifying appropriate trauma units and/or other healthcare facilities having required resources to execute plan of care orders with other facilities and/or locations having required resources to execute said strategies and tactics, plans and operations, regulations and procedures, policies and methods, etc.;
(c) substituting healthcare-industry-related reasons that orders were not executed as indicated with reasons why tactics, operations, procedures and methods utilized by other industries might not be executed as indicated;
(d) substituting patient data and treatment measures with data and measures pertinent to other industries, which may include key performance indicators, production rates, etc.; and
(e) substituting healthcare facility resources types, including healthcare materials, medical equipment, examination and surgery rooms, and healthcare staff with resources utilized by other industries, such as manufacturing and construction equipment, vehicles, raw materials, engineers, designers, etc.;
whereby the functions, advantages and benefits of the invention may be provided to users who are not involved with healthcare.
